(19) United States
(12) Patent Application Publication
(10) Pub. No.: US 2008/0199727 A1
(43) Pub. Date: Aug. 21, 2008

(54) Buffer Layer

(75) Inventors: Poopathy Kathirgamanathan, North Harrow (GB); Subramaniam Ganeshamurugan, London (GB); Muttulingam Kumaraverl, London (GB); Arumugam Partheepan, London (GB); Gnanamoly Paramaswara, London (GB)

Correspondence Address: David Silverstein;ANDOVER-IP-LAW, Suite 300, 44 Park Street, Andover, MA, 01810, US

(73) Assignee: OLED-T LIMITED, Enfield (GB)

(21) Appl. No.: 11/666,766

(22) PCT Filed: Nov. 1, 2005
(86) PCT No.: PCT/GB05/04222

§ 371 Date: Jun. 25, 2007

(30) Foreign Application Priority Data
Nov. 3, 2004 (GB) 0424294.7

(51) Int. Cl. C09K 11/06

(52) U.S. Cl. 428/690

(57) ABSTRACT

Electroluminescent devices with an improved buffer layer on the anode, wherein the buffer material is selected from metal tetra-p-tolyl porphonato complexes, and bianthryl compounds of Formula (I) or (II).

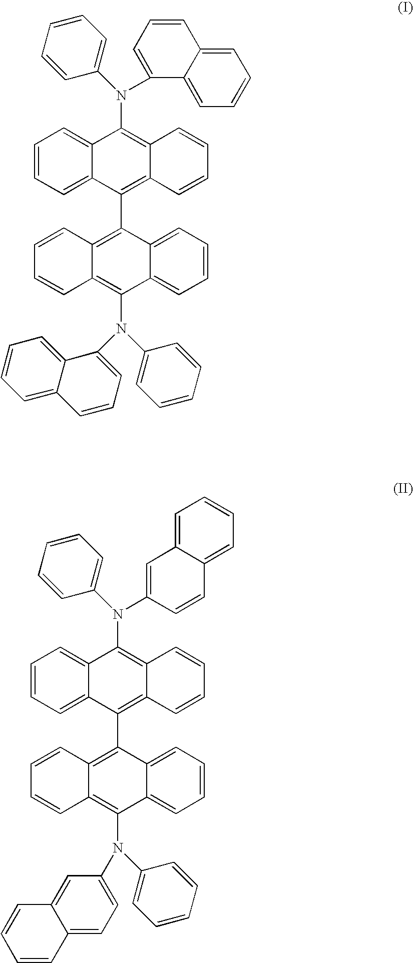

The present invention relates to improved buffer layers in electroluminescent devices and to electroluminescent devices incorporating improved buffer layers.

Materials which emit light when an electric current is passed through them are well known and used in a wide range of display applications. Liquid crystal devices and devices which are based on inorganic semiconductor systems are widely used. However these suffer from the disadvantages of high energy consumption, high cost of manufacture, low quantum efficiency and the inability to make flat panel displays.

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04028, PCT/GB00/00268 describe electroluminescent complexes, structures and devices using rare earth chelates.

Typical electroluminescent devices which are commonly referred to as optical light emitting diodes (OLEDS) comprise an anode, normally of an electrically light transmitting material, a layer of a hole transporting material, a layer of the electroluminescent material, a layer of an electron transporting material and a metal cathode.

U.S. Pat. No. 5,128,587 discloses an electroluminescent device which consists of an organometallic complex of rare earth elements of the lanthanide series sandwiched between a transparent electrode of high work function and a second electrode of low work function with a hole conducting layer interposed between the electroluminescent layer and the transparent high work function electrode and an electron conducting layer interposed between the electroluminescent layer and the electron injecting low work function anode. The hole conducting layer and the electron conducting layer are required to improve the working and the efficiency of the device. The hole conducting or transportation layer serves to transport holes and to block the electrons, thus preventing electrons from moving into the electrode without recombining with holes. The electron conducting or transporting layer serves to transport electrons and to block the holes, thus preventing holes from moving into the electrode without recombining with holes. The recombination of carriers therefore mainly or entirely takes place in the emitter layer.

As described in U.S. Pat. No. 6,333,521 this mechanism is based upon the radiative recombination of a trapped charge. Specifically, OLEDs are comprised of at least two thin organic layers between an anode and a cathode. The material of one of these layers is specifically chosen based on the material's ability to transport holes, a “hole transporting layer” (HTL), and the material of the other layer is specifically selected according to its ability to transport electrons, an “electron transporting layer” (ETL). With such a construction, the device can be viewed as a diode with a forward bias when the potential applied to the anode is higher than the potential applied to the cathode. Under these bias conditions, the anode injects holes (positive charge carriers) into the HTL, while the cathode injects electrons into the ETL. The portion of the luminescent medium adjacent to the anode thus forms a hole injecting and transporting zone while the portion of the luminescent medium adjacent to the cathode forms an electron injecting and transporting zone. The injected holes and electrons each migrate toward the oppositely charged electrode. When an electron and hole localize on the same molecule, a Frenkel exciton is formed. These excitons are trapped in the material which has the lowest energy. Recombination of the short-lived excitons may be visualized as an electron dropping from its conduction potential to a valence band, with relaxation occurring, under certain conditions, preferentially via a photoemissive mechanism.

In an OLED, holes are injected from the HTL and electrons are injected from the ETL into the separate emissive layer, where the holes and electrons combine to form excitons.

Various compounds have been used as HTL materials or ETL materials. HTL materials mostly consist of triaryl amines in various forms which show high hole mobilities (˜10⁻³ cm²/Vs). There is somewhat more variety in the ETLs used in OLEDs. Aluminium tris(8-hydroxyquinolate) (Alq₃) is the most common ETL material, and others include oxidiazol, triazol, and triazine.

In order to improve the performance of OLEDs, buffer layers have been used between the electrodes and the adjacent layers. The use of a buffer layer can reduce or eliminate performance failures such as electrical shorts and non-radiative regions (dark spots). Typical performance failures are described in Antoniadas, H., et al., “Failure Modes in Vapor-Deposited Organic LEDs,” Macromol. Symp., 125, 59-67 (1997). The performance reliability of OLEDs can be influenced by a number of factors. For example, defects in, particles on, and general variations in the morphology at the surface of the materials comprising the substrate and electrode layers can cause or exacerbate performance failures that can occur in OLEDs. Particles or defects on the surface of the substrate or electrode layer may prevent the electrode surface from being coated uniformly during the deposition process. This can cause shadowed regions close to the particle or defect. Shadowed areas provide pathways for water, oxygen, and other detrimental agents to come into contact with and degrade the various lamp layers. This degradation can lead to dark spots which can grow into larger and larger non-emissive regions. This degradation can lead to immediate device failure due to electrical shorting or slower, indirect failure caused by interaction of the OLED layers with the atmosphere. The planarization provided by a conformal buffer layer can mitigate these imperfections.

U.S. Pat. No. 6,333,521 discloses organic materials that are present as a glass, as opposed to a crystalline or polycrystalline form, are disclosed for use in the organic layers of an OLED, since glasses are capable of providing higher transparency as well as producing superior overall charge carrier characteristics as compared with the polycrystalline materials that are typically produced when thin films of the crystalline form of the materials are prepared. However, thermally induced deformation of the organic layers may lead to catastrophic and irreversible failure of the OLED if a glassy organic layer is heated above its T_{g}. In addition, thermally induced deformation of a glassy organic layer may occur at temperatures lower than T_{g}, and the rate of such deformation may be dependent on the difference between the temperature at which the deformation occurs and T_{g}. Consequently, the lifetime of an OLED may be dependent on the T_{g} of the organic layers even if the device is not heated above T_{g}. As a result, there is a need for organic materials having a high T_{g} that can be used in the organic layers of an OLED.

It is important that the buffer layer next to the anode has good hole transporting properties, is transparent at the thickness used and thermally stable and has a high T_{g}.

However there is a general inverse correlation between the T_{g} and the hole transporting properties of a material, i.e. materials having a high T_{g} generally have poor hole transporting properties. Using a buffer material with good hole transporting properties leads to an OLED having desirable properties such as higher quantum efficiency, lower resistance across the OLED, higher power quantum efficiency, and higher luminance.

In addition a suitable buffer layer can reduce the operating voltage of the OLED which can improve the efficiency and extend the operating life of the OLED.

Buffer layers which have been used include polymers such as disclosed in U.S. Pat. Nos. 6,611,096, 6,614,176 and 6,593,690 and organo metallic complexes such as copper phthalocyanines.

We have now discovered compounds which can be used as buffer layers in electroluminescent devices which have a high T_{g} and an improved combination of the other properties.

According to the invention there is provided an electroluminescent device which comprises (i) a first electrode which is the anode (ii) a buffer layer incorporating a buffer material (iii) a layer of an electroluminescent material and (iv) a second electrode which is the cathode in which the buffer material is selected from metal tetra-p-tolyl porphonato complexes, and compounds of formula

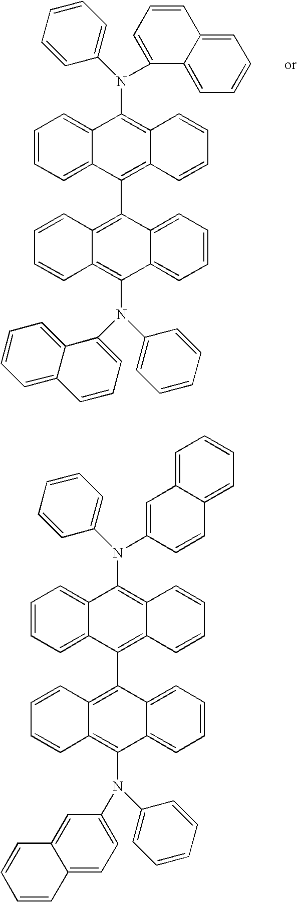

The buffer layer is preferably from 5 to 50 nm in thickness.

The preferred metal in the metal tetra-p-tolyl porphonato complex is zinc.

This compound has a T_{g}>226° C. and a Tₘ>420° C.

Electroluminescent compounds which can be used as the electroluminescent material in the present invention are of general formula (Lα)ₙM where M is a rare earth, lanthanide or an actinide, Lα is an organic complex and n is the valence state of M.

Other organic electroluminescent compounds which can be used in the present invention are of formula

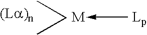

where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example, (L₁)(L₂)(L₃)(L . . )M(Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . ) is equal to the valence state of the metal M. Where there are 3 groups Lα which corresponds to the III valence state of M the complex has the formula (L₁)(L₂)(L₃)M (Lp) and the different groups (L₁)(L₂)(L₃) may be the same or different.

Lp can be monodentate, bidentate or polydentate and there can be one or more ligands Lp.

Preferably M is a metal ion having an unfilled inner shell and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III), Er(III), Yb(III) and more preferably Eu(III), Tb(III), Dy(III), Gd (III), Er (III), Yt(III).

Further organic electroluminescent compounds which can be used in the present invention are of general formula (Lα)ₙM₁M₂ where M₁ is the same as M above, M₂ is a non rare earth metal, Lα is as above and n is the combined valence state of M₁ and M₂. The complex can also comprise one or more neutral ligands Lp so the complex has the general formula (Lα)ₙM₁ M₂ (Lp), where Lp is as above. The metal M₂ can be any metal which is not a rare earth, transition metal, lanthanide or an actinide. Examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium. titanium, vanadium, zirconium, tantalum, molybdenum, rhodium, iridium, titanium, niobium, scandium, yttrium.

For example (L₁)(L₂)(L₃)(L . . )M (Lp) where M is a rare earth, transition metal, lanthanide or an actinide and (L₁)(L₂)(L₃)(L . . . ) and (Lp) are the same or different organic complexes.

Further organometallic complexes which can be used in the present invention are binuclear, trinuclear and polynuclear organometallic complexes e.g. of formula (Lm)ₓ M₁←M₂(Ln)_{y} e.g.

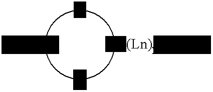

where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula

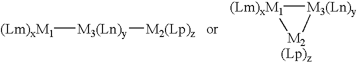

where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group.

For example the metals can be linked by bridging ligands e.g.

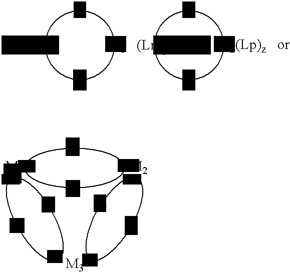

where L is a bridging ligand.

By polynuclear is meant there are more than three metals joined by metal to metal bonds and/or via intermediate ligands

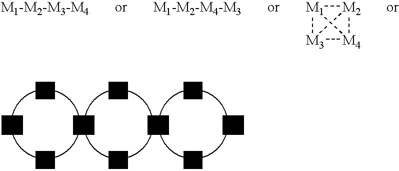

where M₁, M₂, M₃ and M₄ are rare earth metals and L is a bridging ligand.

Preferably Lα is selected from a diketones such as those of formulae

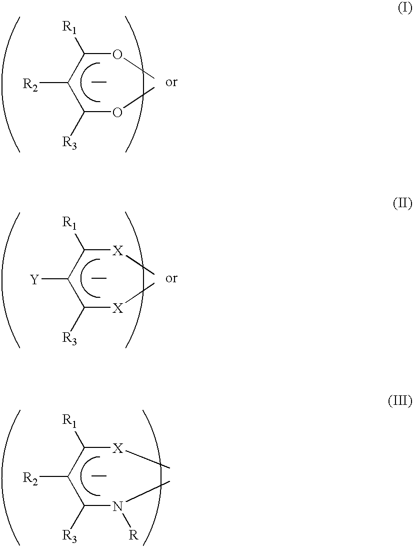

where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

The beta diketones can be polymer substituted beta diketones and in the polymer, oligomer or dendrimer substituted P diketone the substituents group can be directly linked to the diketone or can be linked through one or more —CH₂ groups i.e.

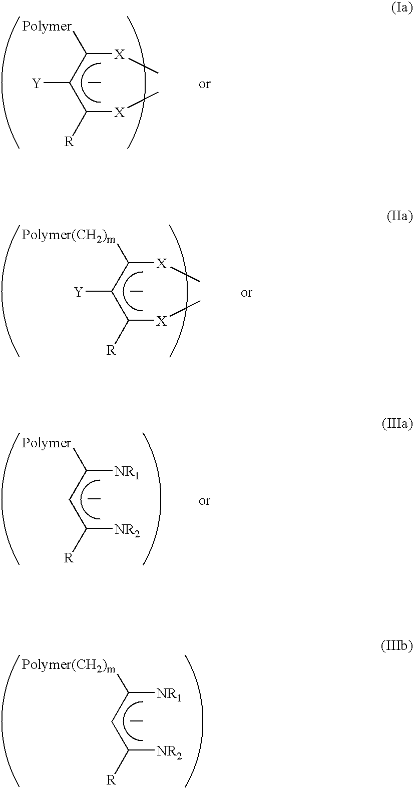

or through phenyl groups e.g.

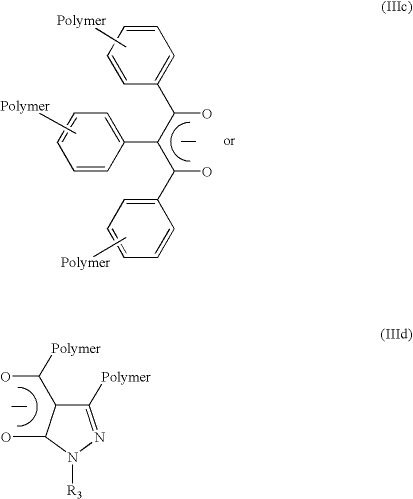

where “polymer” can be a polymer, an oligomer or a dendrimer, (there can be one or two substituted phenyl groups as well as three as shown in (IIIc)) and where R is selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups Lα may also be the same or different charged groups such as carboxylate groups so that the group L₁ can be as defined above and the groups L₂, L_{3 . . .} can be charged groups such as

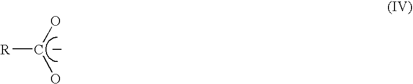

where R is R₁ as defined above or the groups L₁, L₂ can be as defined above and L_{3 . . .} etc. are other charged groups.

R₁, R₂ and R₃ can also be

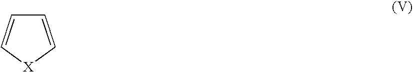

where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups Lα may be the same or different ligands of formulae

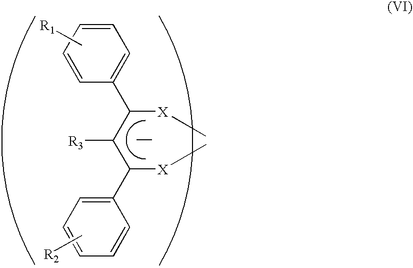

where X is O, S, or Se and R₁ R₂ and R₃ are as above.

The different groups Lα may be the same or different quinolate derivatives such as

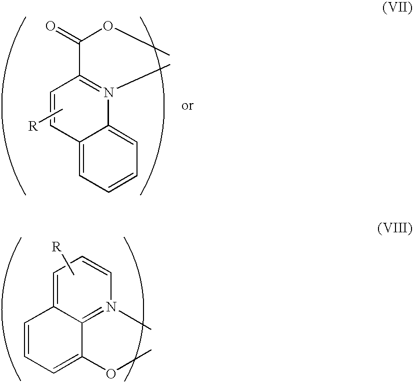

where R is hydrocarbyl, aliphatic, aromatic or heterocyclic carboxy, aryloxy, hydroxy or alkoxy e.g. the 8 hydroxy quinolate derivatives or

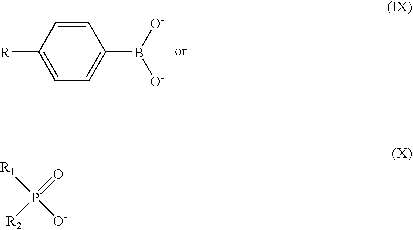

where R, R₁, and R₂ are as above or are H or F e.g. R₁ and R₂ are alkyl or alkoxy groups

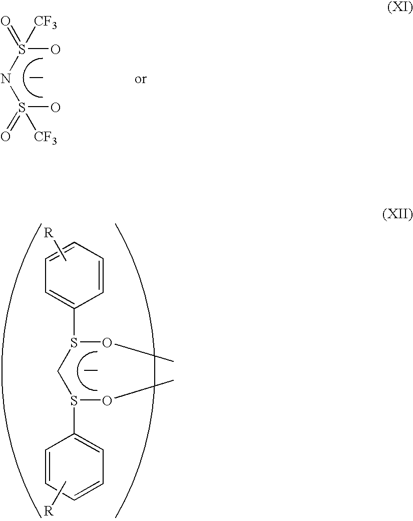

As stated above the different groups Lα may also be the same or different carboxylate groups e.g.

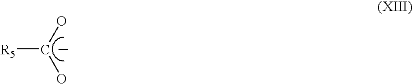

where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be

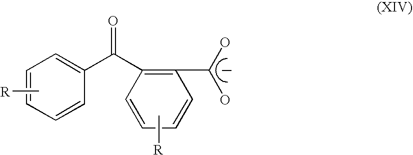

where R is as above e.g. alkyl, allenyl, amino or a fused ring such as a cyclic or polycyclic ring.

The different groups Lα may also be

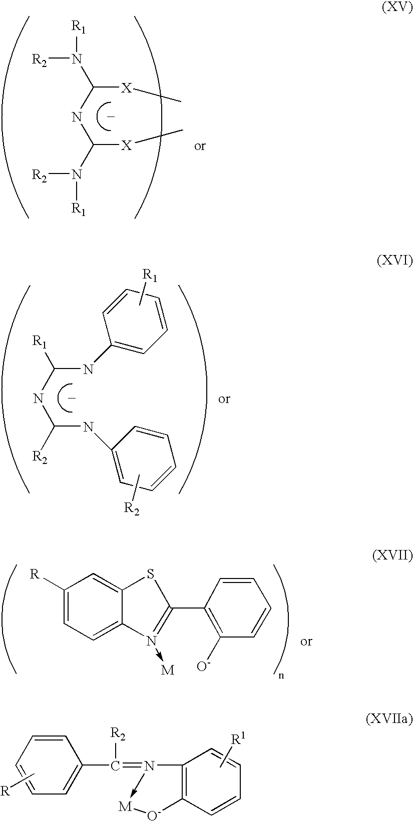

where R, R₁ and R₂ are as above.

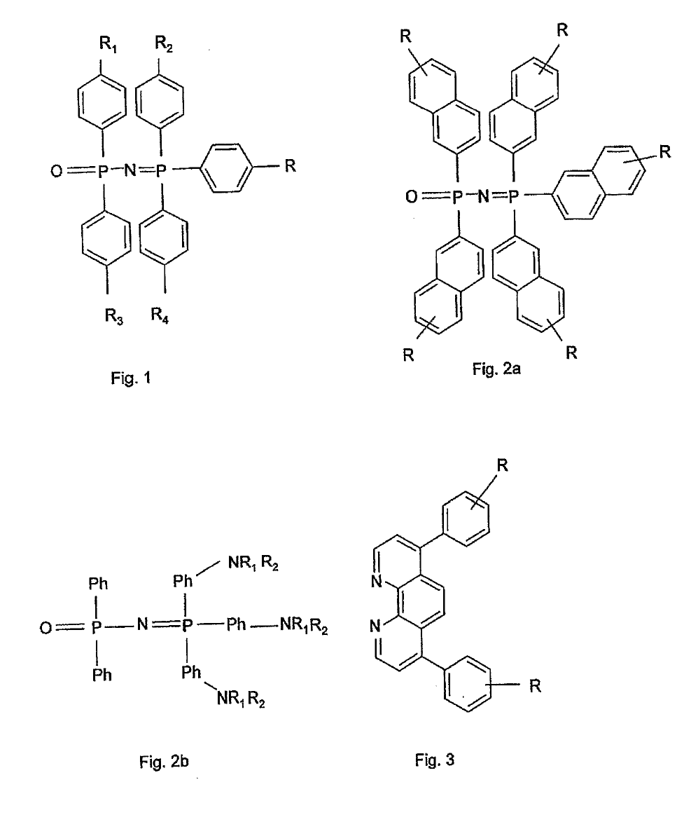

The groups L_{P} can be selected from

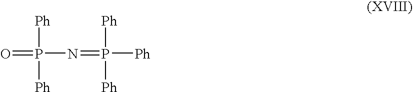

where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino, substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups

—C—CH₂═CH₂—R

where R is as above.

Lₚ can also be compounds of formulae

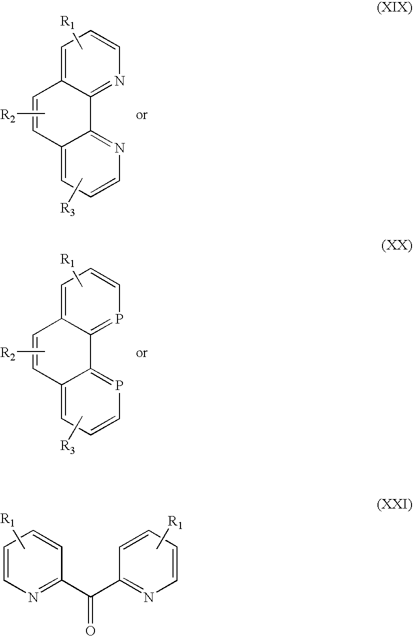

where R₁, R₂ and R₃ are as referred to above, for example bathophen shown in FIG. 3 of the drawings in which R is as above or

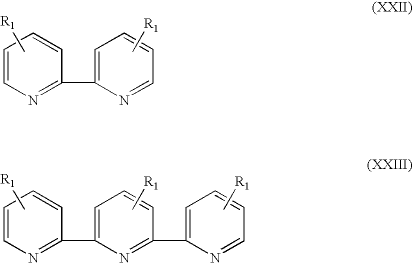

where R₁, R₂ and R₃ are as referred to above.

Lₚ can also be

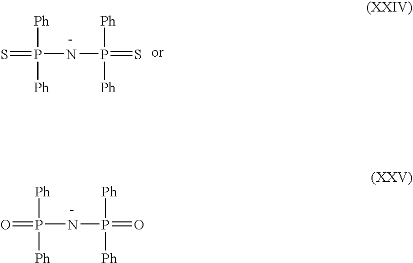

where Ph is as above.

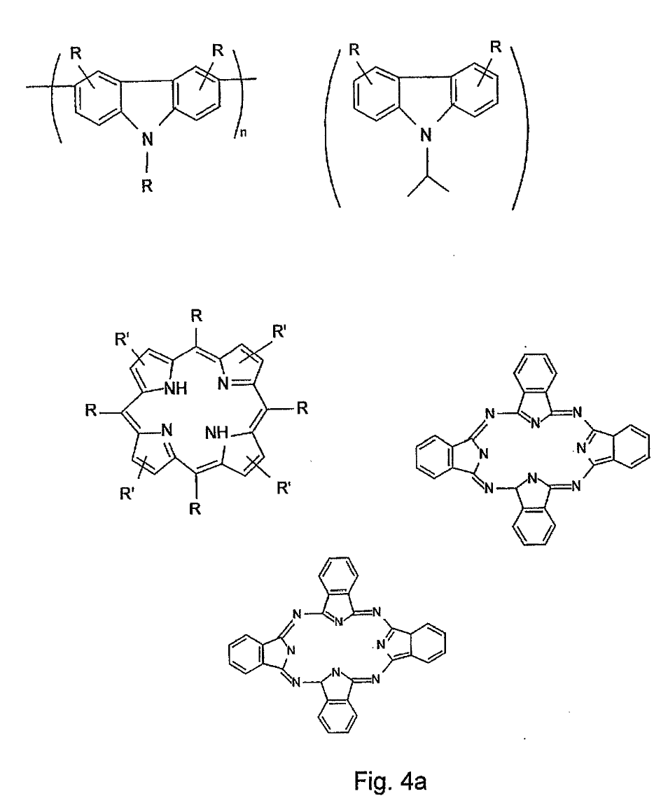

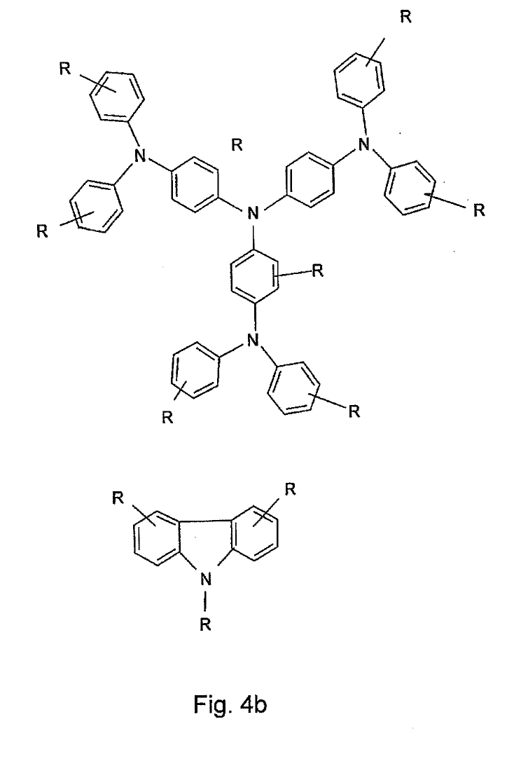

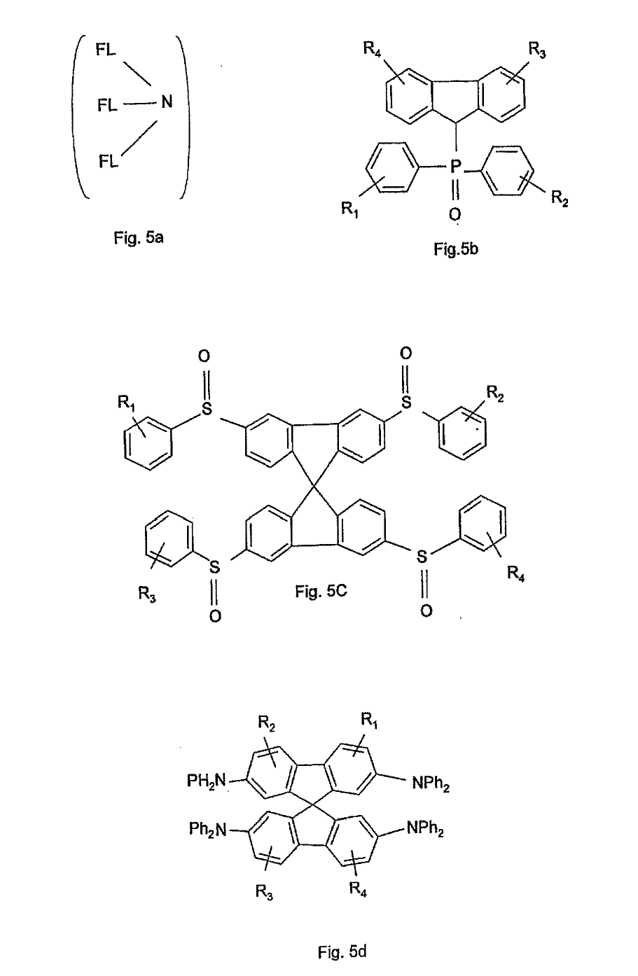

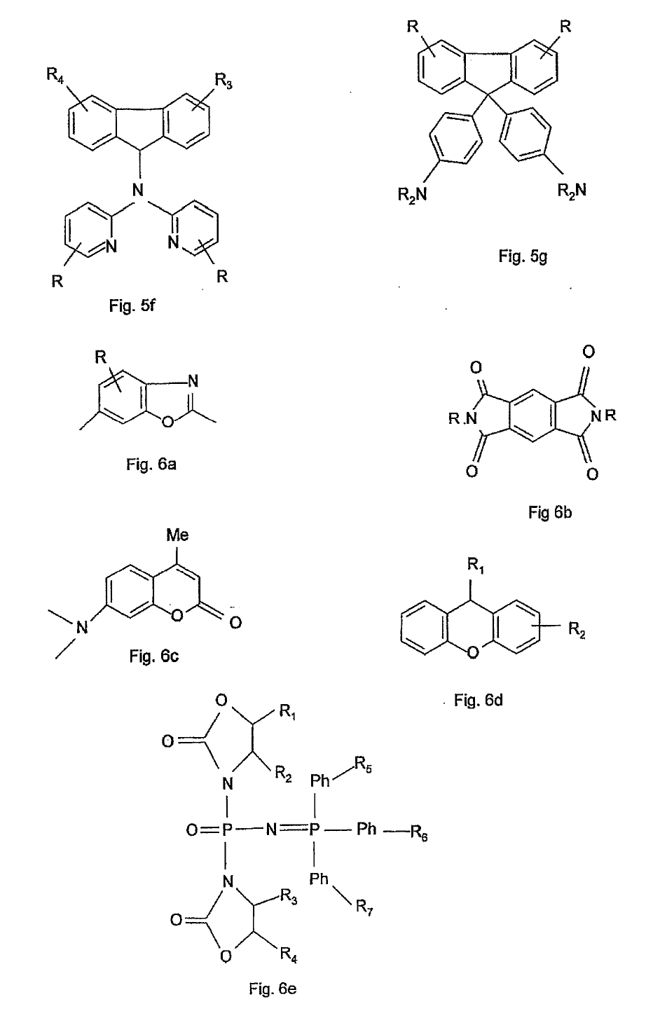

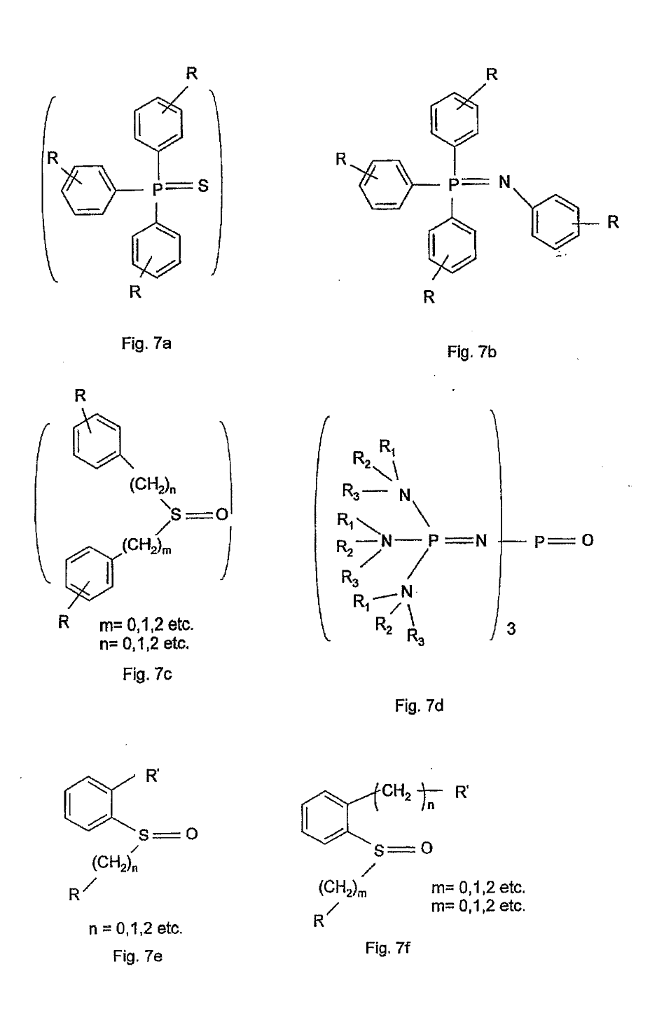

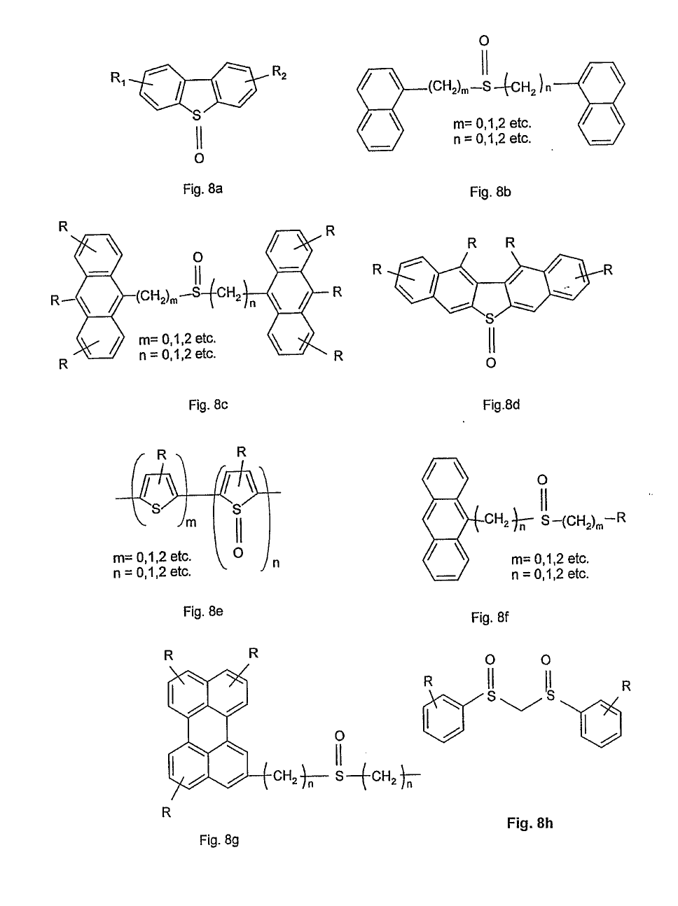

Other examples of Lₚ chelates are as shown in FIG. 4 and fluorene and fluorene derivatives e.g. a shown in FIG. 5 and compounds of formulae as shown as shown in FIGS. 6 to 8.

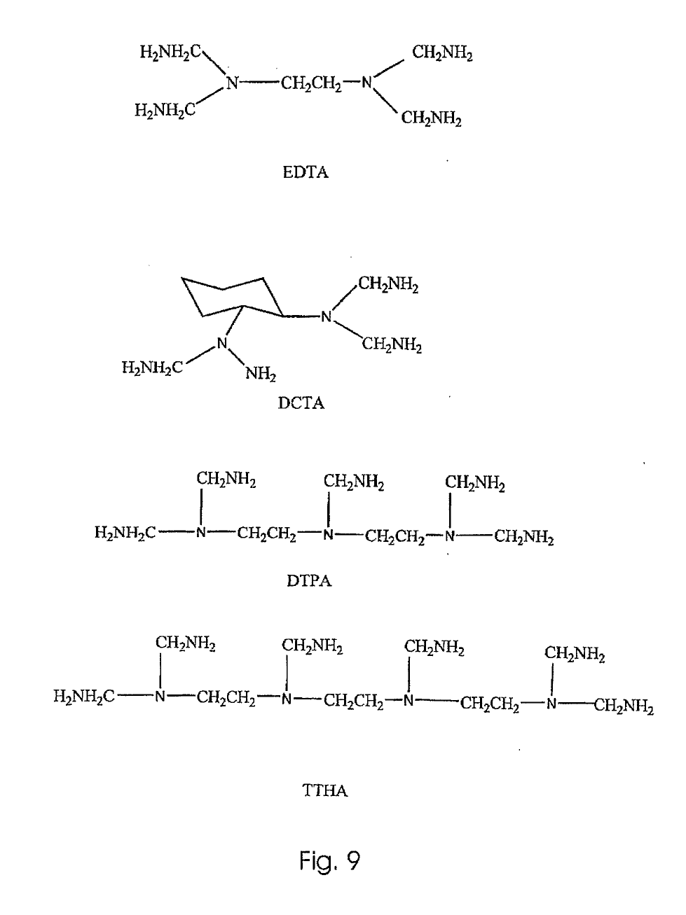

Specific examples of Lα and Lp are tripyridyl and TMHD, and TMHD complexes, α, α′, α″ tripyridyl, crown ethers, cyclans, cryptans phthalocyanans, porphoryins ethylene diamine tetramine (EDTA), DCTA, DTPA and TTHA, where TMHD is 2,2,6,6-tetramethyl-3,5-heptanedionato and OPNP is diphenylphosphonimide triphenyl phosphorane. The formulae of the polyamines are shown in FIG. 9.

Other organic electroluminescent materials which can be used include metal quinolates such as lithium quinolate, and non rare earth metal complexes such as aluminium, magnesium, zinc and scandium complexes such as complexes of β-diketones e.g. Tris-(1,3-diphenyl-1-3-propanedione) (DBM) and suitable metal complexes are Al(DBM)₃, Zn(DBM)₂ and Mg(DBM)₂, Sc(DBM)₃ etc.

Other organic electroluminescent materials which can be used include the metal complexes of formula

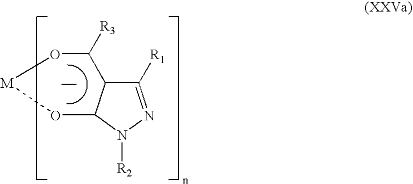

where M is a metal other than a rare earth, a transition metal, a lanthanide or an actinide; n is the valency of M; R₁, R₂ and R₃ which may be the same or different are selected from hydrogen, hydrocarbyl groups, substituted and unsubstituted aliphatic groups substituted and unsubstituted aromatic, heterocyclic and polycyclic ring structures, fluorocarbons such as trifluoryl methyl groups, halogens such as fluorine or thiophenyl groups or nitrile; R₁, and R₃ can also be form ring structures and R₁, R₂ and R₃ can be copolymerisable with a monomer e.g. styrene. Preferably M is aluminium and R₃ is a phenyl or substituted phenyl group.

Other organic electroluminescent materials which can be used include electroluminescent diiridium compounds of formula

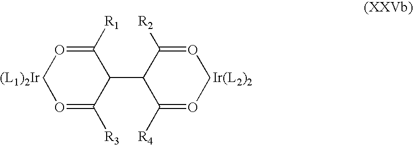

where R₁, R₂, R₃ and R₄ can be the same or different and are selected from hydrogen, and substituted and unsubstituted hydrocarbyl groups; preferably R₁, R₂, R₃ and R₄ are selected from substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer and L₁ and L₂ are the same or different organic ligands and more preferably L₁ and L₂ are selected from phenyl pyridine and substituted phenylpryidines.

Other iridum complexes which can be used include electroluminescent complexes of formula

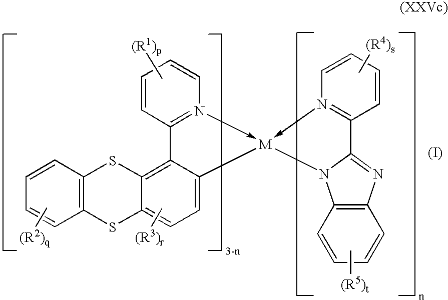

wherein M is ruthenium, rhodium, palladium, osmium, iridium or platinum; n is 1 or 2; R¹, R⁴ and R⁵ can be the same or different and are selected from substituted and unsubstituted hydrocarbyl groups; substituted and unsubstituted monocyclic and polycyclic heterocyclic groups; substituted and unsubstituted hydrocarbyloxy or carboxy groups; fluorocarbyl groups; halogen; nitrile; amino; alkylamino; dialkylamino; arylamino; diarylamino; and thiophenyl; p, s and t independently are 0, 1, 2 or 3; subject to the proviso that where any of p, s and t is 2 or 3 only one of them can be other than saturated hydrocarbyl or halogen; R² and R³ can be the same or different and are selected from; substituted and unsubstituted hydrocarbyl groups; halogen; q and r independently are 0, 1 or 2 and complexes of formula

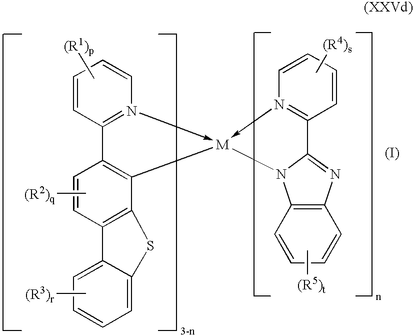

wherein M is ruthenium, rhodium, palladium, osmium, iridium or platinum; n is 1 or 2; R¹-R⁵ which may be the same or different are selected from substituted and unsubstituted hydrocarbyl groups; substituted and unsubstituted monocyclic and polycyclic heterocyclic groups; substituted and unsubstituted hydrocarbyloxy or carboxy groups; fluorocarbyl groups; halogen; nitrile; nitro; amino; alkylamino; dialkylamino; arylamino; diarylamino; N-alkylamido, N-arylamido, sulfonyl and thiophenyl; and R² and R³ can additionally be alkylsilyl or arylsilyl; p, s and t independently are 0, 1, 2 or 3; subject to the proviso that where any of p, s and t is 2 or 3 only one of them can be other than saturated hydrocarbyl or halogen; q and r independently are 0, 1 or 2, subject to the proviso that when q or r is 2, only one of them can be other than saturated hydrocarbyl or halogen, compounds of formula

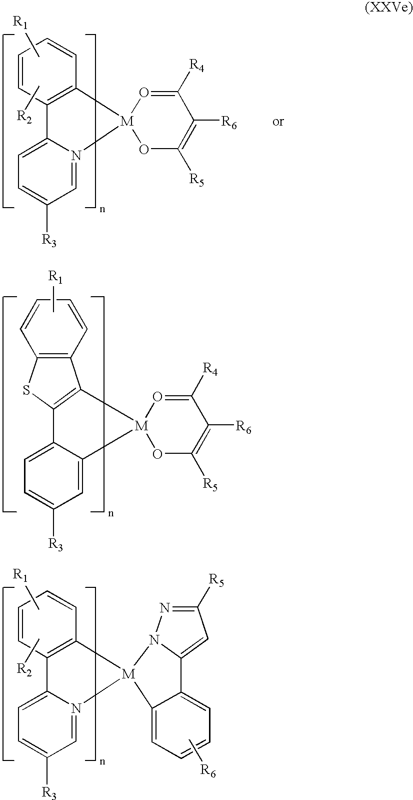

where R₁, R₂, R₃ , R₄, R₅ and R₆ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene, and where R₄, and R₅ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, M is ruthenium, rhodium, palladium, osmium, iridium or platinum and n+2 is the valency of M,

and electroluminescent compounds of formula

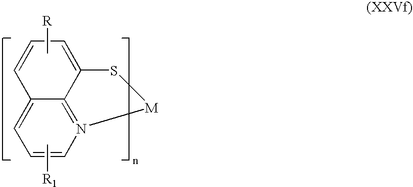

where M is a metal; n is the valency of M; R and R₁ which can be the same or different are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine; thiophenyl groups; cyano group; substituted and unsubstituted hydrocarbyl groups such as substituted and unsubstituted aliphatic groups, substituted and unsubstituted aliphatic groups.

In another electroluminescent structure the electroluminescent layer is formed of layers of two electroluminescent organic complexes in which the band gap of the second electroluminescent metal complex or organo metallic complex such as a gadolinium or cerium complex is larger than the band gap of the first electroluminescent metal complex or organo metallic complex such as a europium or terbium complex.

Other electroluminescent compounds which can be used are of formula

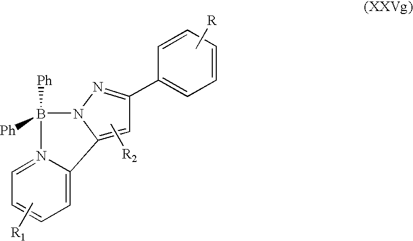

where Ph is an unsubstituted or substituted phenyl group where the substituents can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R, R₁ and R₂ can be hydrogen or substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R and/or R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Further electroluminescent materials which can be used include metal quinolates such as aluminium quinolate, lithium quinolate, zirconium quinolate etc. and metal quinolates doped with fluorescent materials or dies as disclosed in patent application WO/2004/058913.

Preferably there is a layer of a hole transporting material between the buffer layer and the layer of the electroluminescent compound.

The hole transporting material can be any of the hole transporting materials used in electroluminescent devices.

The hole transporting material can be an amine complex such as poly(vinylcarbazole), N,N′-diphenyl-N,N′-bis(3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of

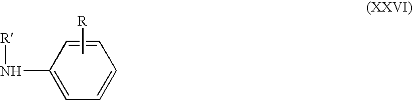

where R is in the ortho- or meta-position and is hydrogen, C1-18 alkyl, C1-6 alkoxy, amino, chloro, bromo, hydroxy or the group

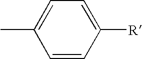

where R is alkyl or aryl and R′ is hydrogen, C1-6 alkyl or aryl with at least one other monomer of formula I above.

Or the hole transporting material can be a polyaniline; polyanilines which can be used in the present invention have the general formula

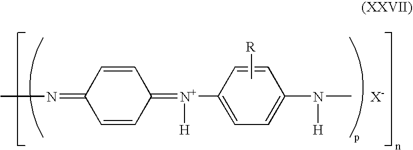

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate; an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated then it can be easily evaporated i.e. the polymer is evaporable.

Preferably evaporable deprotonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P 319 1989.

The conductivity of the polyaniline is dependent on the degree of protonation with the maximum conductivity being when the degree of protonation is between 40 and 60%, e.g. about 50%.

Preferably the polymer is substantially fully deprotonated.

A polyaniline can be formed of octamer units, i.e. p is four, e.g.

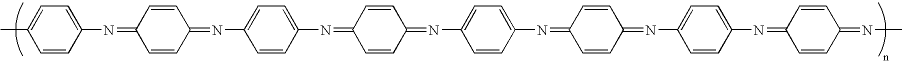

The polyanilines can have conductivities of the order of 1×10⁻¹ Siemen cm⁻¹ or higher.

The aromatic rings can be unsubstituted or substituted, e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted, e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly(p-phenylenevinylene)-PPV and copolymers including PPV. Other preferred polymers are poly(2,5 dialkoxyphenylene vinylene) such as poly(2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents, e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as an anthracene or a naphthlyene ring and the number of vinylene groups in each polyphenylenevinylene moiety can be increased, e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm thick.

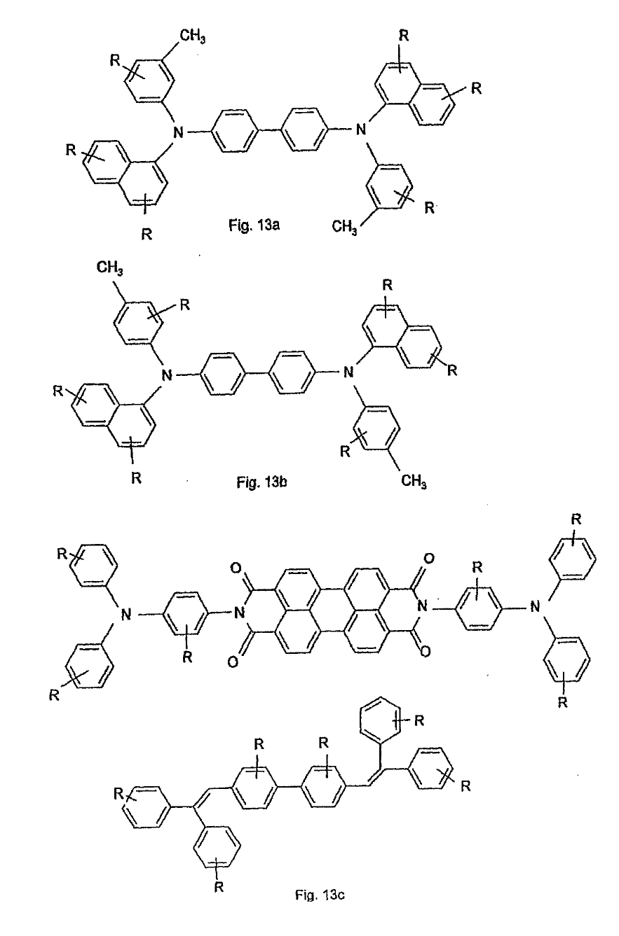

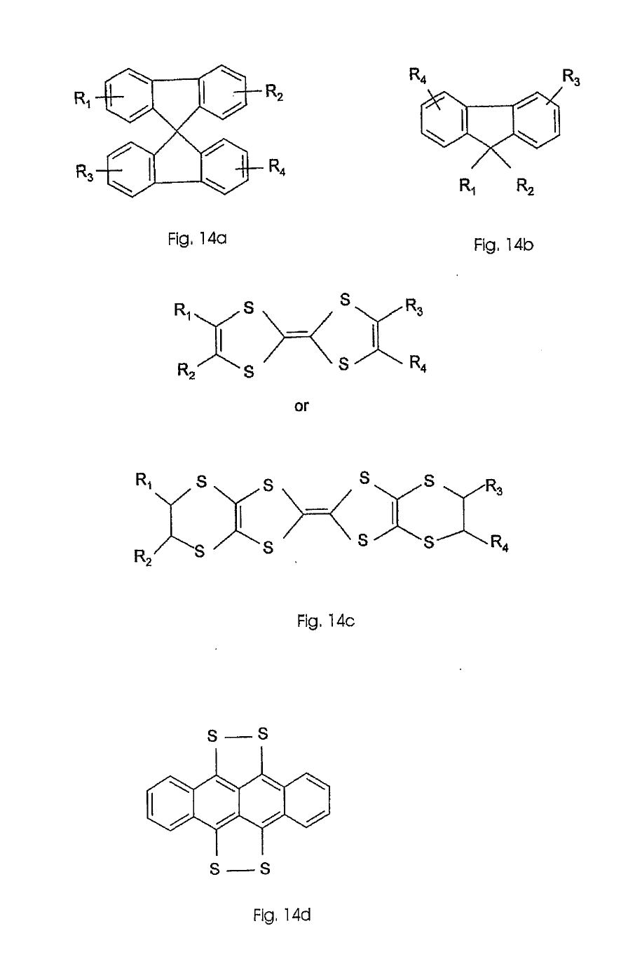

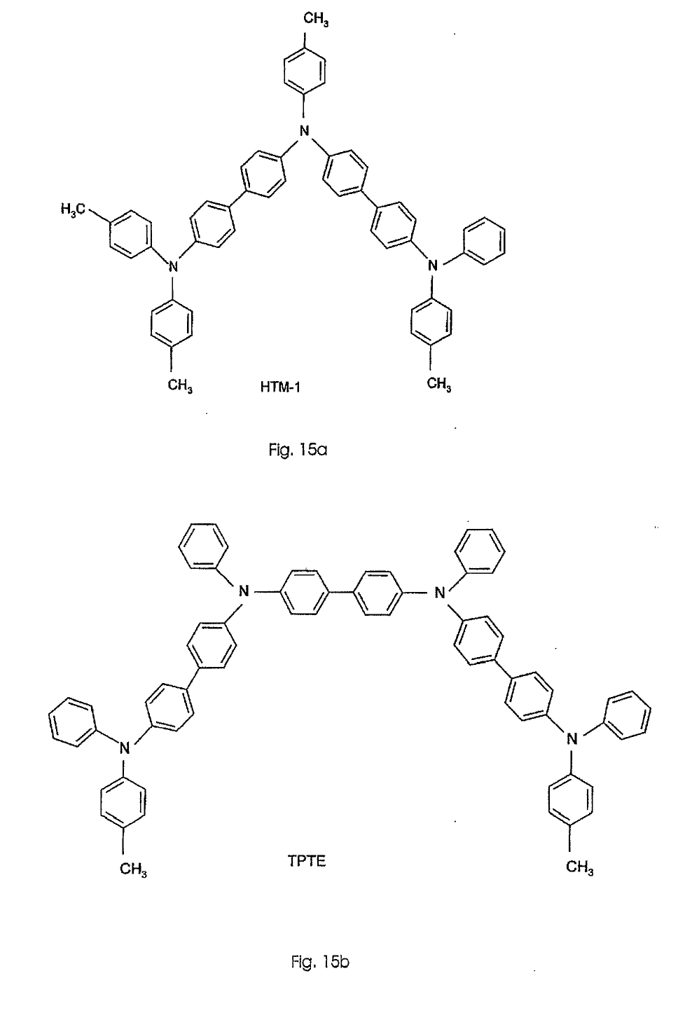

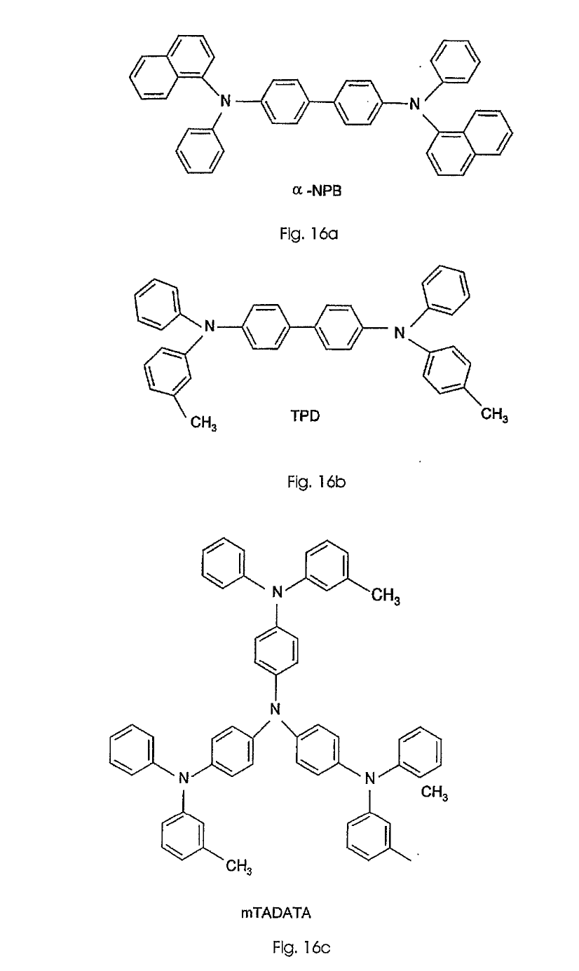

The structural formulae of some other hole transporting materials are shown in FIGS. 12, 13, 14, 15 and 16 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

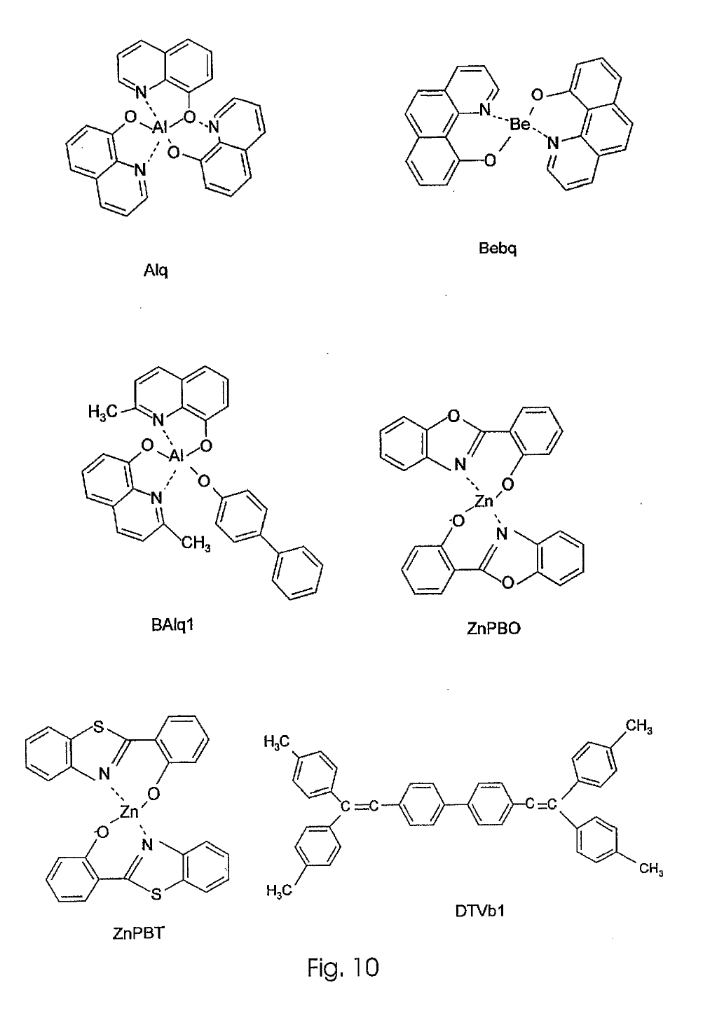

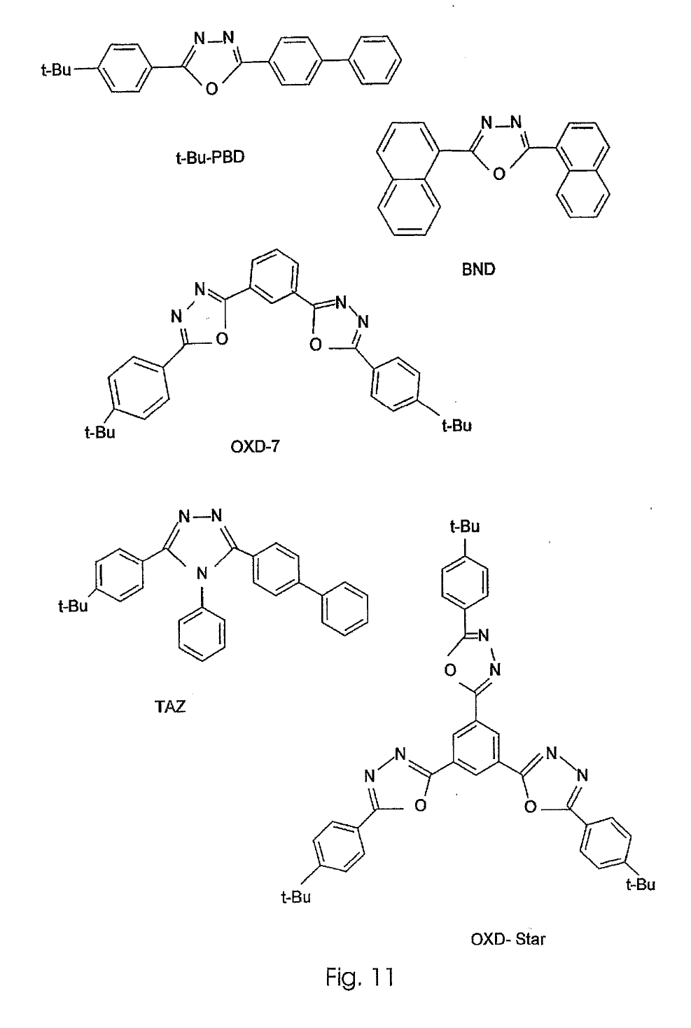

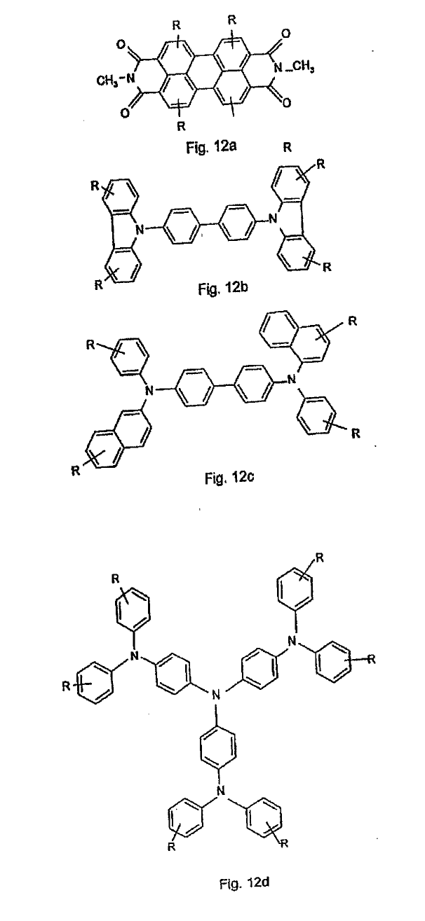

Optionally there is a layer of an electron injecting material between the cathode and the electroluminescent material layer, the electron injecting material is a material which will transport electrons when an electric current is passed through electron injecting materials include a metal complex such as a metal quinolate, e.g. an aluminium quinolate, lithium quinolate, Mx(DBM)ₙ where Mx is a metal and DBM is dibenzoyl methane and n is the valency of Mx, e.g Mx is chromium, a cyano anthracene such as 9,10 dicyano anthracene, cyano substituted aromatic compounds, tetracyanoquinidodimethane a polystyrene sulphonate or a compound with the structural formulae shown in FIG. 10 or 11 of the drawings in which the phenyl rings can be substituted with substituents R as defined above. Instead of being a separate layer the electron injecting material can be mixed with the electroluminescent material and co-deposited with it.

Optionally the hole transporting material can be mixed with the electroluminescent material and co-deposited with it.

The hole transporting materials, the electroluminescent material and the electron injecting materials can be mixed together to form one layer, which simplifies the construction.

The first electrode is preferably a transparent substrate such as a conductive glass or plastic material which acts as the anode. Preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The cathode is preferably a low work function metal, e.g. aluminium, calcium, lithium, magnesium and alloys thereof such as silver/magnesium alloys, rare earth metal alloys etc; aluminium is a preferred metal. A metal fluoride such as an alkali metal, rare earth metal or their alloys can be used as the second electrode, for example by having a metal fluoride layer formed on a metal.

The devices of the present invention can be used as displays in video displays, mobile telephones, portable computers and any other application where an electronically controlled visual image is used. The devices of the present invention can be used in both active and passive applications of such as displays.

In known electroluminescent devices either one or both electrodes can be formed of silicon and the electroluminescent material and intervening layers of hole transporting and electron transporting materials can be formed as pixels on the silicon substrate. Preferably each pixel comprises at least one layer of an electroluminescent material and a (at least semi-)transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode, the cathode can be formed of a transparent electrode which has a suitable work function; for example by an indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers; for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

An advantage of at least one embodiment of the present invention is the reduction or elimination of mobile counterions in an organic electronic device. Preferably, counterion mobility is reduced or eliminated in the buffer layer of such a device. It is advantageous to immobilize these counterions because it is believed that they can migrate in the electrode structure and interfere with the movement of positive charges or electrons in the device and another advantage of at least one embodiment of the present invention is the avoidance of undesirable operating voltage increase over time and a further advantage of at least one embodiment of the present invention is increased device lifetime and higher operating reliability.

The invention is illustrated in the Examples.

### EXAMPLE 1

Synthetic procedure for the preparation of 5,10,15,20-tetra-p-tolylporphine)zinc(II)
(ZnTpTP) (A)

| | | |
|---|---|---|
| Materials required | | |
| 5,10,15,20-Tetra-p-tolyl-21H,23H-porphine (TpTP) | 97% | Aldrich |
| Lithium bis(trimethylsilyl)amide (LiN(SiMe₃)₂) | 97% | Aldrich |
| Zinc(II) chloride¹ (ZnCl₂) | 98.0% | BDH |
| Ethylene glycol dimethyl ether, anhydrous (DME)² | 99.5% | Aldrich |
| Toluene³ | Analar | BDH |
| Chloroform | Analar | BDH |

Synthetic scheme

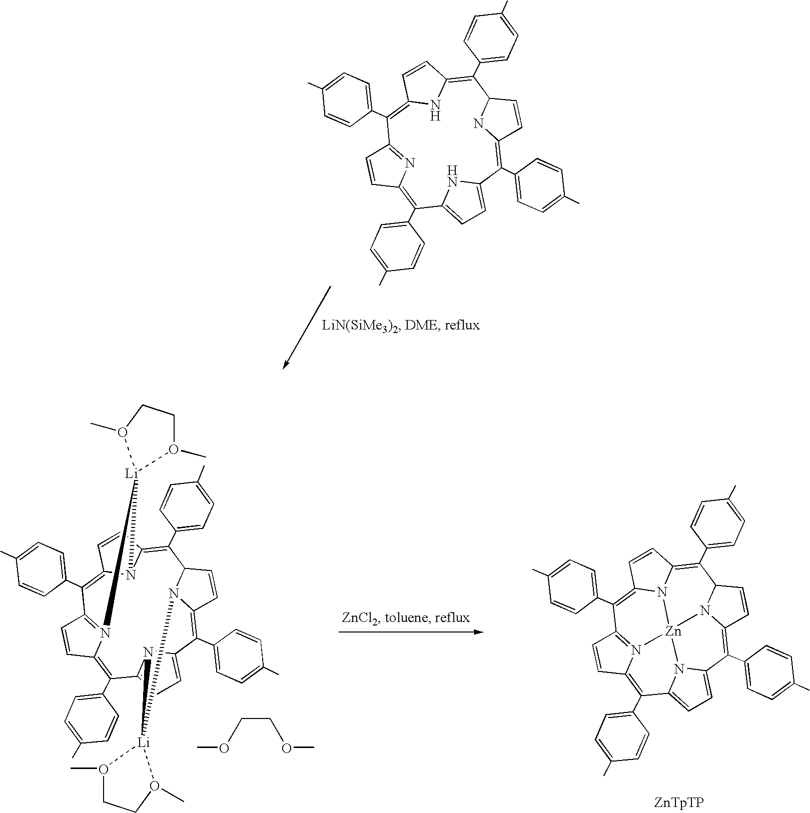

¹ZnCl₂ was stored in vacuum oven at 100° C. for 72 h before use.
²Solvent degassed using freeze-pump-thaw cycles prior to use
³Distilled from Na/benzophenone prior to use

Experimental

### Preparation of the dilithium salt of 5,10,15,20-tetra-p-tolylporphine

A flame dried Schlenk tube, under an atmosphere of argon, was charged with LiN(SiMe₃)₂ (4.0 g, 24 mmol) and TpTP (8.0 g, 12 mmol). DME (50 mL) was added via cannula and the mixture refluxed under argon for 8 h. On cooling, Li₂(DME)ₓ(TpTP) (x=2-3) was formed as a bright purple powder. The product was filtered off and dried in vacuo for several hours. Yield 10.5 g (92-99%).

Preparation of ZnTpTP (A)

A flame dried Schlenk tube under an atmosphere of argon was charged with Li₂(DME)₃(TpTP) (10.5 g, 12 mmol) and ZnCl₂ (3.3 g, 24 mmol). Toluene (50 mL) was added via cannula and the mixture refluxed under argon for 4-5 hours, after which the mixture was bright purple. The mixture was hot filtered and washed 3 times with hot chloroform (50 mL). The solvent was removed from the filtrate and the residue was soxhlet extracted with 200 mL toluene for 72 h. On cooling the toluene solution yielded dark purple crystals, which were isolated by filtration. The crystals were washed with hexane and dried in a vacuum oven at 100° C. for 24 h. Yield 5.6 g (64%).

### EXAMPLE 2

### Synthesis of N*10*,N*10′*-Di-naphthalen-1-yl-N*10*,N*10′*-diphenyl-[9,9′]bianthracenyl-10,10′-diamine (B)

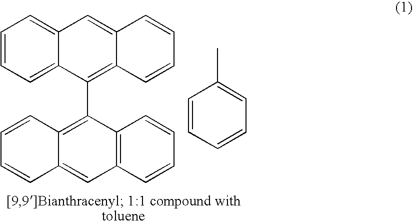

Anthrone (bought from Avocado, 97% (40.00 g, 206 mmol) was refluxed in a mixture of glacial acetic acid (200 ml) and concentrated hydrochloric acid (80 ml). To this refluxing solution granulated tin (80 g, 674 mmol) was cautiously added. The reaction was refluxed for 15 h during which time a white precipitate formed. The mixture was cooled to room temperature and the solution was carefully filtered under vacuum to isolate the precipitate but leave unreacted tin in the reaction vessel. The precipitate was washed with water (100 ml) and dried in a vacuum oven. This solid was then recrystalised from the minimum amount of hot toluene (approx' 500 ml) to yield light yellow crystals of the 1:1 [9,9′]Bianthracenyl/Toluene adduct (37 g, 81% yield).

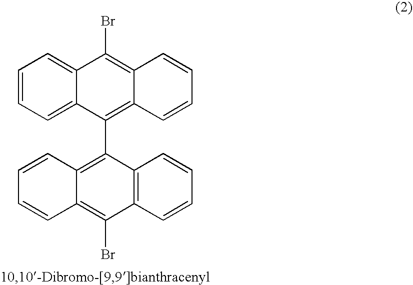

1:1 [9,9′]Bianthracenyl/Toluene adduct (30 g, 67.2 mmol) was dissolved and stirred in carbon disulphide (100 ml) at room temperature. To this solution bromine (6.9 ml, 134.7 mmol) was added drop wise. Hydrogen bromide fumes were evolved and the mixture was stirred for a further 2 h. After this period n-Hexane (150 ml) was added and a large amount of yellow solid precipitated. This solid was filtered under vacuum, washed with n-Hexane and dried. This solid was 10,10′-Dibromo-[9,9′]bianthracenyl (27 g, 78%); m.p. 357-359° C.

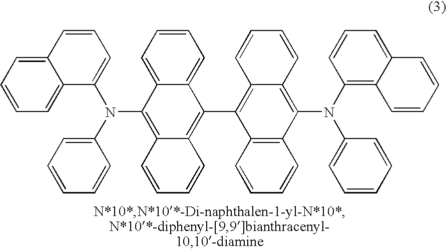

10,10′-Dibromo-[9,9′]bianthracenyl (10 g, 19.5 mmol), N-phenyl-1-naphthylamine (40 mmol), Sodium tert-butoxide (4.15 g, 96 mmol), Palladium(II)acetate (0.088 g, 0.39 mmol) and tri-tert-butyl-phosphane 10 % wt in hexane (5.5 ml, 1.6 mmol) were stirred in dry o-Xylene (100 ml) under an atmosphere of dry Argon gas. This mixture was heated to 120° C. for 3 h. The initial dark solution became lighter and thick with precipitate over this period. The reaction mixture was cooled to room temperature, mixed thoroughly with 250 ml of methanol, filtered under vacuum and washed with a small amount of methanol. The solid was stirred thoroughly in 250 ml of hot water, filtered under vacuum, washed with 250 ml of cold water and then 250 ml of methanol. The solid was dried and then sublimed under high vacuum (approx. 10⁻⁶ Torr) to give the pure product._Yield: 86%. This was sublimed twice to give an orange-yellow amorphous solid. M.p>400° C.

A and B synthesised as above were tested as buffer layers in electroluminescent devices and compared with the use of copper phthalocyanine as a buffer layer, which is the widely used buffer layer.

### EXAMPLE 3

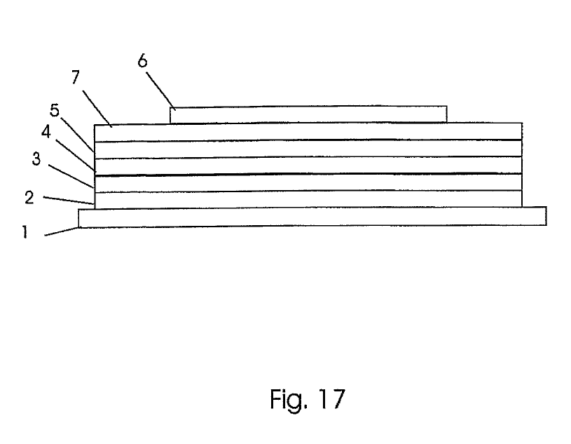

A pre-etched ITO coated glass piece (10×10 cm²) was used. The device was fabricated by sequentially forming on the ITO, by vacuum evaporation using a Solciet Machine, ULVAC Ltd. Chigacki, Japan the active area of each pixel was 3mm by 3 mm, the device is shown in FIG. 17 and the layers comprised:

(1) ITO/(2) B (20 nm)/(3) α-NPB (65 nm)/(4) C:Liq-2Me (25:0.1 nm)/(5)Hfq₄ (20 nm)/(6) LiF (0.3 nm)/(7) Al

where ITO is indium tin oxide coated glass, α-NPB is shown in FIG. 17 of the drawings, C is as below (p. 39), Liq-2Me is 2-methyl lithium quinolate and Hfq₄ is hafnium quinolate.

The coated electrodes were stored in a vacuum desiccator over a molecular sieve and phosphorous pentoxide until they were loaded into a vacuum coater (Edwards, 10⁻⁶ torr) and aluminium top contacts made. The devices were then kept in a vacuum desiccator until the electroluminescence studies were performed.

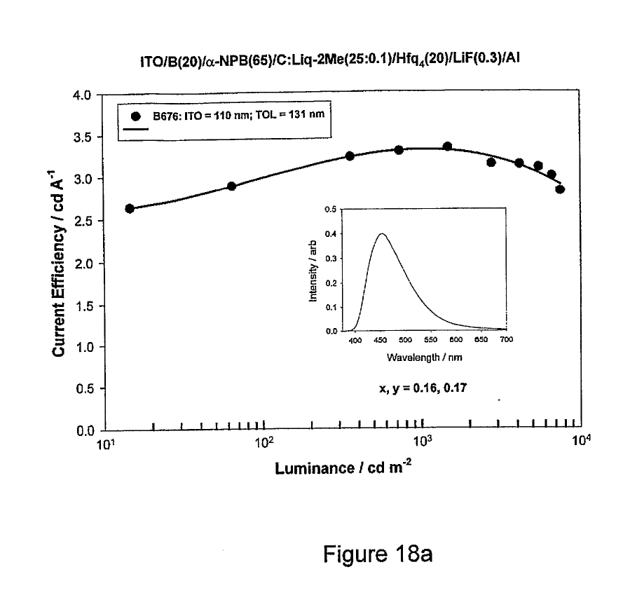

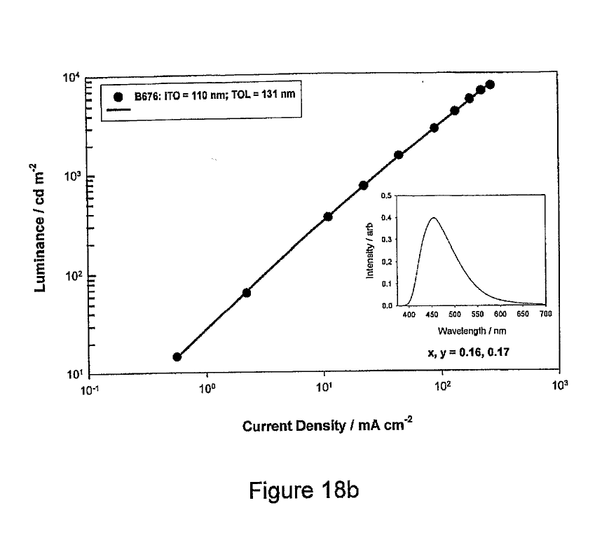

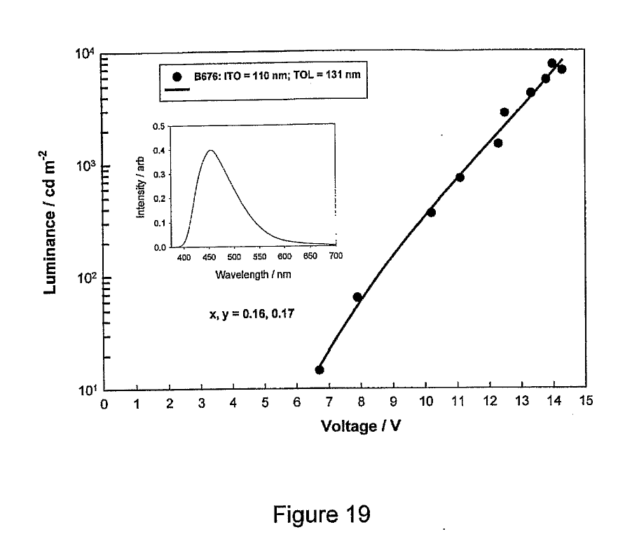

The ITO electrode was always connected to the positive terminal. The current vs. voltage studies were carried out on a computer controlled Keithly 2400 source meter. The performance is shown in FIGS. 18 and 19.

### EXAMPLE 4

A series of devices were made as in Example 3 and compared with devices using a copper phthalocyanine buffer layer.

The devices had the structures in the following examples.

### EXAMPLE 5

(1) ITO/(2) B (20 nm)/(3) α-NPB (45 nm)/(4) CBP:D (20:0.5 nm)/(5)BCP (6 nm)/(6) LiF (0.5 nm)/(7) Al and

(1) ITO/(2) CuPc (10 nm)/(3) α-NPB (45 nm)/(4) CBP:D (20:0.5 nm)/(5)BCP (6 nm)/(6) LiF (0.5 nm)/(7) Al

where CBP has the formula of FIG. 12b, BCP is bathocupron and D is a green phosphorescent compound of the formula below (p. 39).

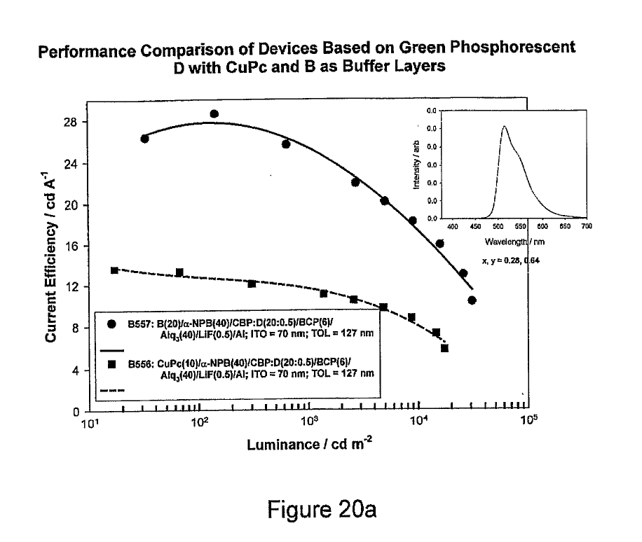

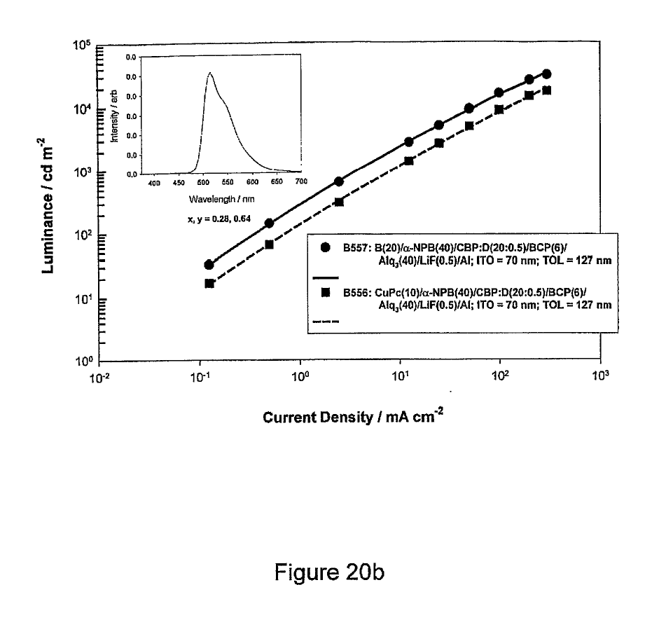

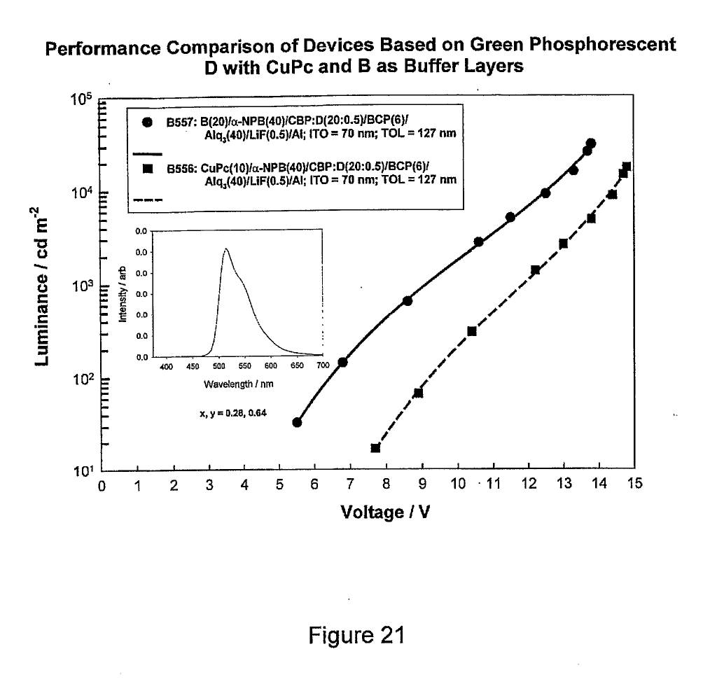

The performance is shown in FIGS. 20 and 21.

### EXAMPLE 6

(1) ITO/(2) B (5 nm)/(3) α-NPB (20 nm)/(4) CBP:E (20:1.6 nm)/(5)BCP (6 nm)/(6) Zrq₄(30 nm)/(7) LiF(0.5) (8) Al and

(1) ITO/(2) CuPc (5 nm)/(3) α-NPB (20 nm)/(4) CBP:E (20:1.6 nm)/(5)BCP (6 nm)/(6) Zrq₄(30 nm)/(7) LiF(0.5) (8) Al

where E is green phosphorescent compound as below (p. 39).

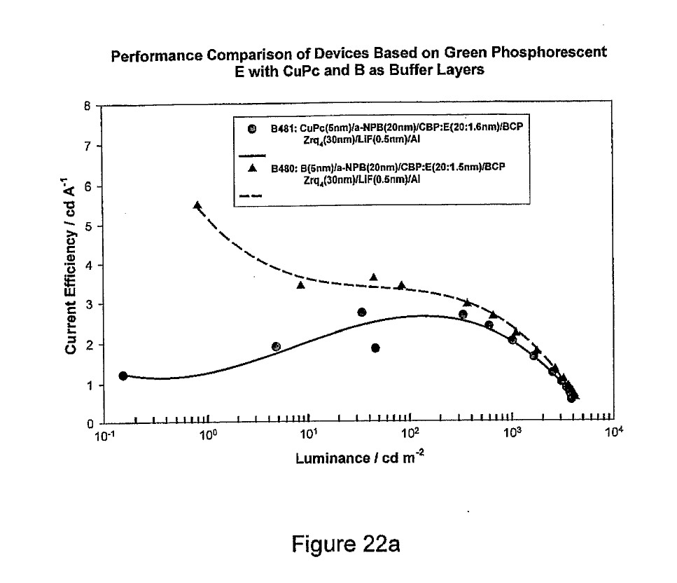

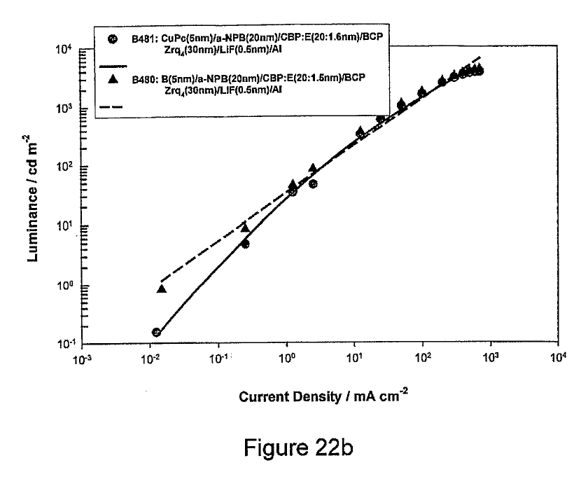

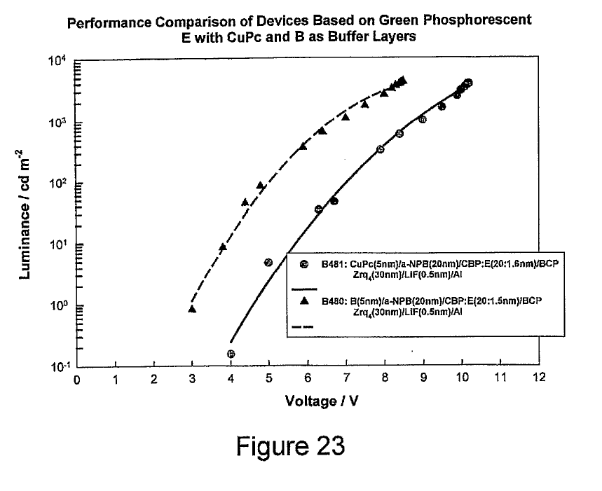

The performance is shown in FIGS. 22 and 23.

### EXAMPLE 7

(1) ITO/(2) B (20 nm)/(3) α-NPB (50 nm)/(4) Zrq₄:DPQA(40:0.1)/(5) Zrq₄(20 nm)/LiF(0.3) (8) Al and

(1) ITO/(2) A (20 nm)/(3) α-NPB (50 nm)/(4) Zrq₄:DPQA(40:0.1)/(5) Zrq₄(20 nm)/LiF(0.3) (8) Al and

(1) ITO/(2) CuPc (20 nm)/(3) α-NPB (50 nm)/(4) Zrq₄:DPQA(40:0.1)/(5)/Zrq₄(20 nm)/LiF(0.3) (8) Al

where DPQA is diphenylquinacridone, Zrq₄ is zirconium quinolate and the Zrq₄:DPQA layer was formed by concurrent vacuum deposition to form a zirconium quinolate layer doped with DPQA. The weight ratio of the Zrq₄ and DPQA is conveniently shown by a relative thickness measurement.

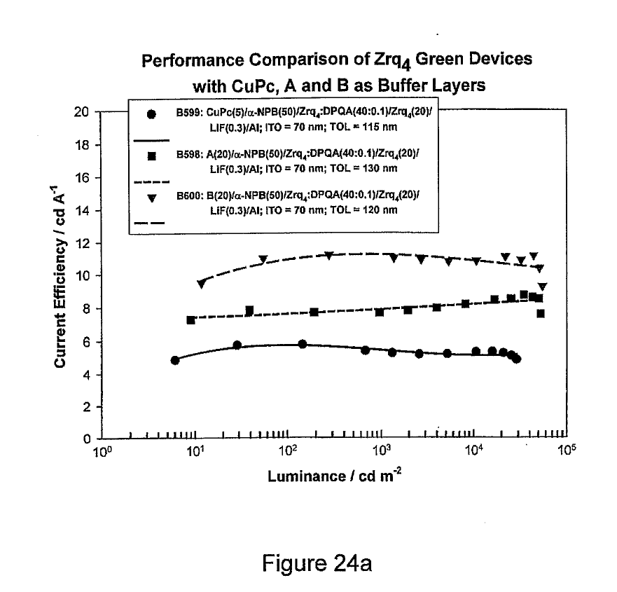

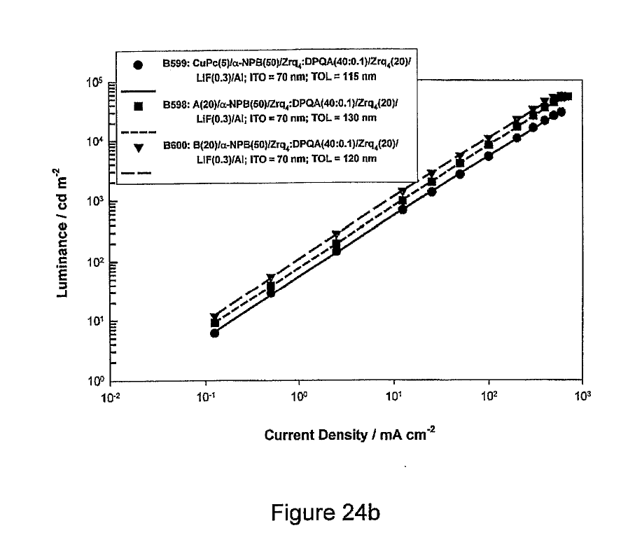

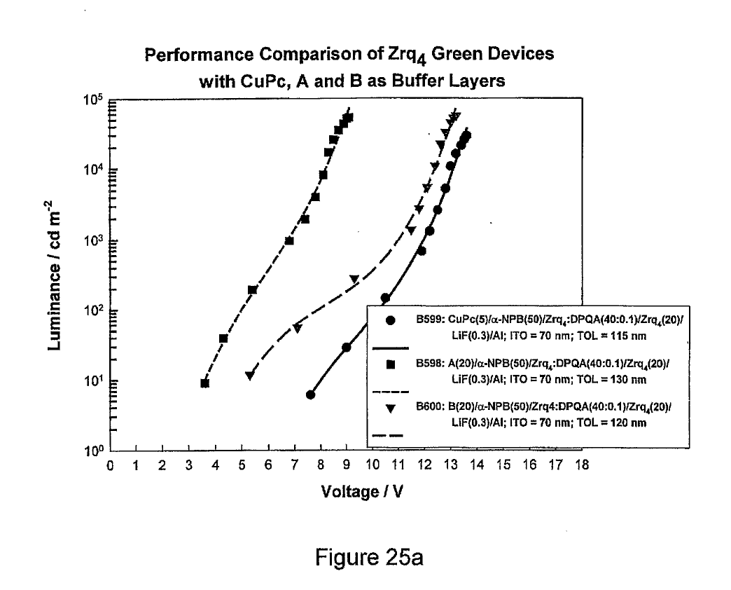

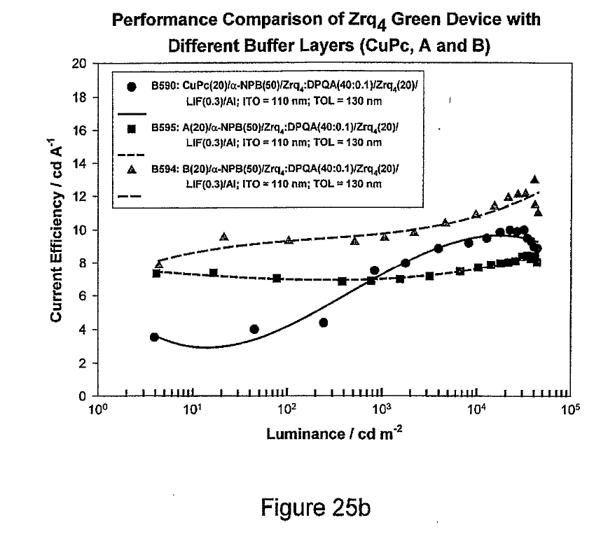

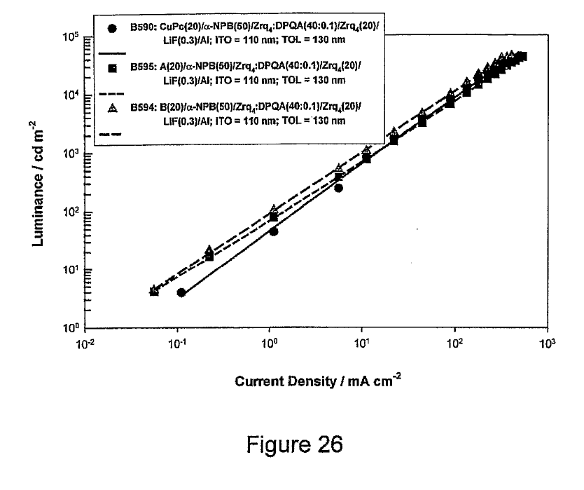

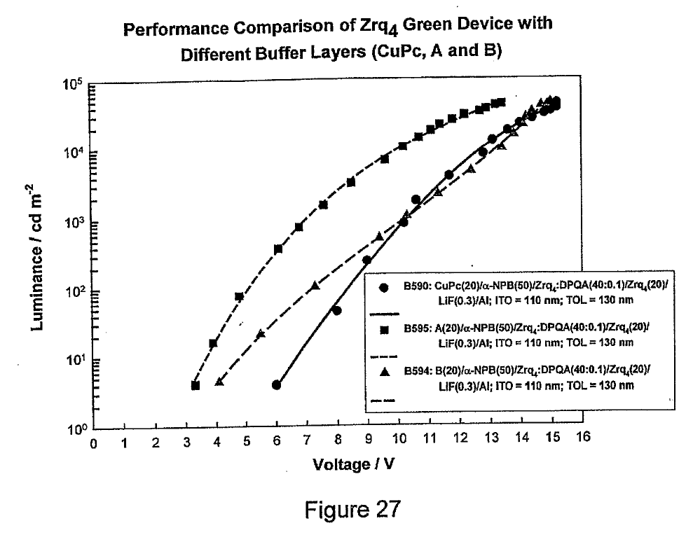

The performance is shown in FIGS. 24, 25, 26 and 27.

### EXAMPLE 8

(1)ITO/(2)/B(5 nm)/(3)α-NPB(60 nm)/(4)CBP:E(30:0.2 nm)/(5) Zrq₄(30 nm)/(6)LiF(0.3)/(7) Al and

(1)ITO/(2)/A(5 nm)/(3)α-NPB(60 nm)/(4)CBP:E(30:0.2 nm)/(5) Zrq₄(30 nm)/(6)LiF(0.3)/(7) Al and

(1)ITO/(2)/CuPc(5 nm)/(3)α-NPB(60 nm)/(4)CBP:E(30:0.2 nm)/(5) Zrq₄(30 nm)/(6)LiF(0.3)/(7) Al and

(1)ITO/(2)/α-NPB(60 nm)/(3)CBP:E(30:0.2 nm)/(4)Zrq₄(30 nm)/(5)LiF(0.3)/(6) Al.

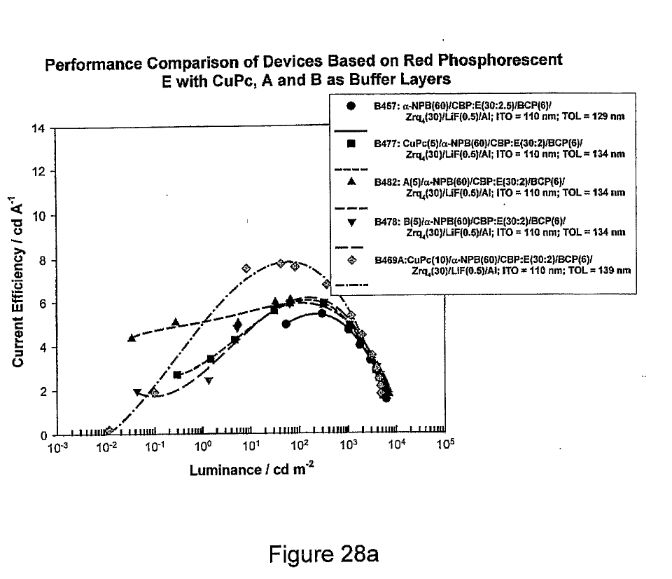

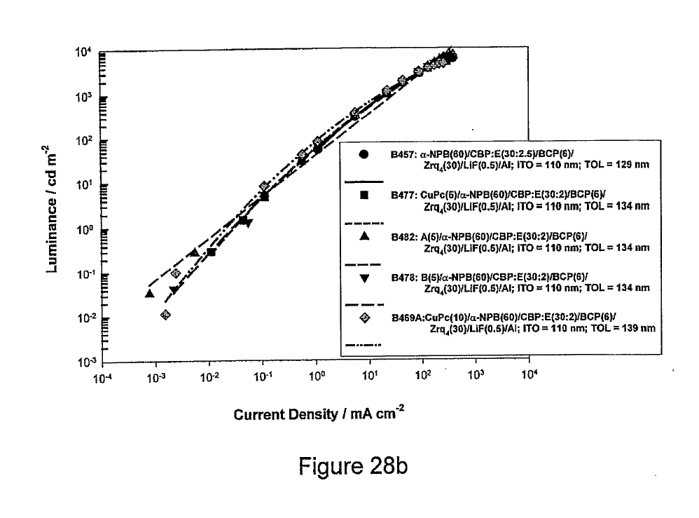

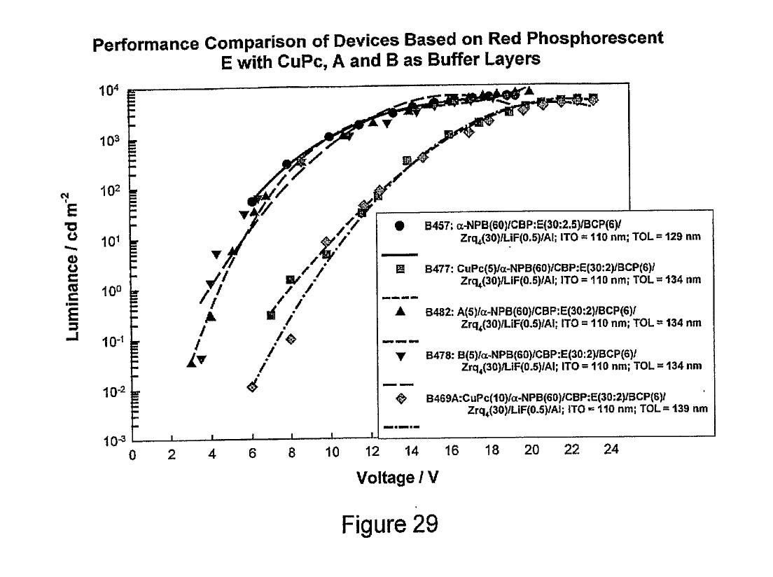

The performance is shown in FIGS. 28 and 29.

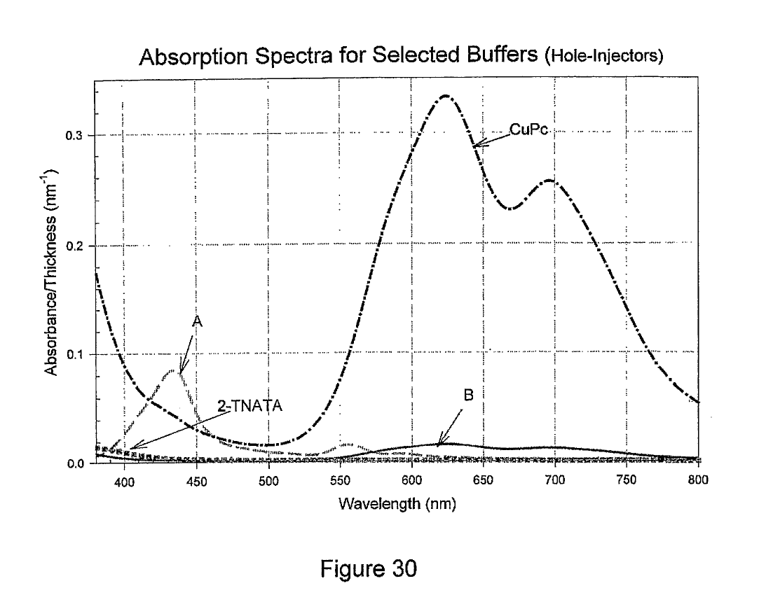

In FIG. 30 is shown the absorbance spectra of A, B and CuPc.

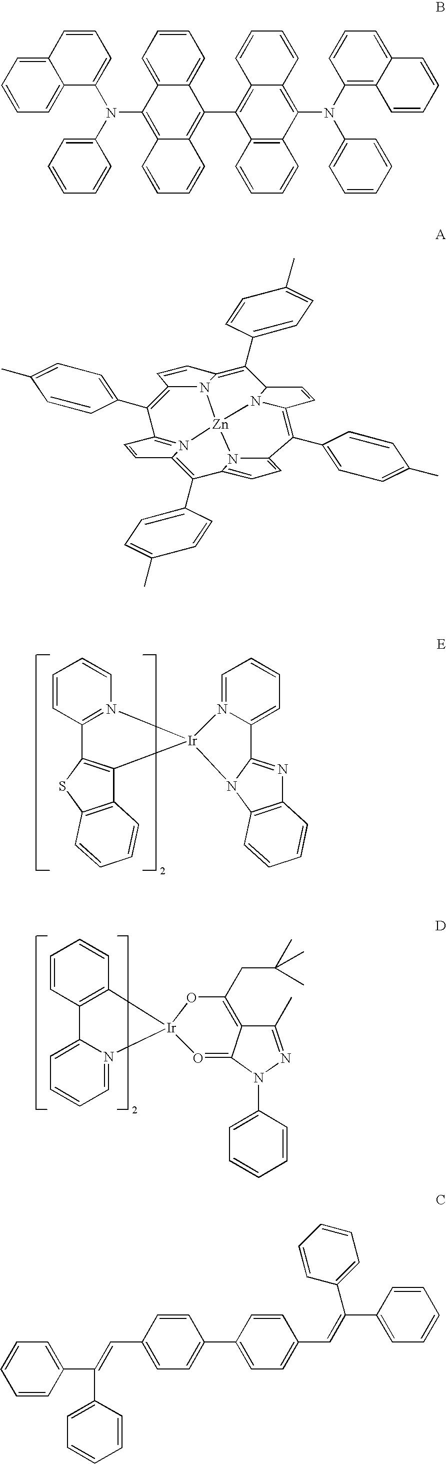

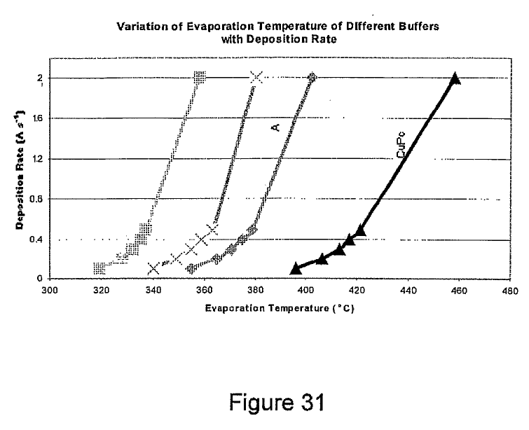

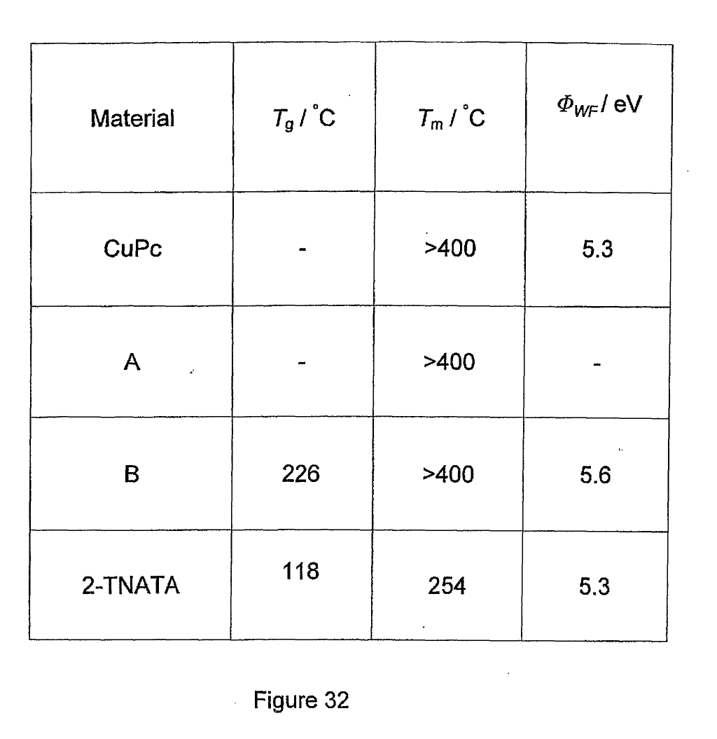

FIG. 31 shows the variation of evaporation temperature with deposition rates and FIG. 32 is a Table showing the properties of the various buffers.

1.-34. (canceled)

35. An electroluminescent device comprising: (i) a first electrode which serves as an anode; (ii) a buffer layer incorporating a buffer material; (iii) a layer of an electroluminescent material; and (iv) a second electrode which serves as a cathode, wherein the buffer material is selected from the group consisting of metal tetra-p-tolyl porphonato complexes, and compounds having one of the following two general chemical formulas:

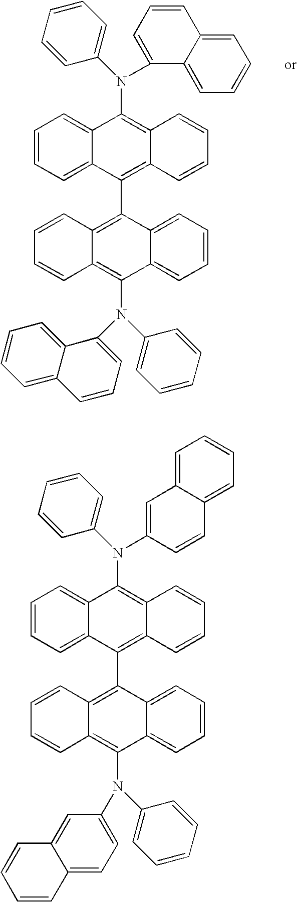

36. The device of claim 35, in which the buffer layer has a thickness of about 5 to 50 nm.

37. The device of claim 35, in which the electroluminescent material is a metal quinolate having the general chemical formula Mqₙ where M is a metal, n is the valence of the metal, and q is a substituted or unsubstituted quinolate ion.

38. The device of claim 37, in which the metal M is lithium, zirconium or aluminum.

39. The device of claim 37, wherein the metal quinolate is doped with a fluorescent material or dye.

40. The device of claim 35 in which the electroluminescent material is an electroluminescent non rare earth metal complex selected from the group consisting of:
(a) a rare earth metal complex;
(b) an aluminum, magnesium, zinc or scandium complex;
(c) a β-diketone complex;
(d) Al(TDP)₃, Zn(TDP)₂ and Mg(TDP)₂, Sc(TDP)₃, and mixtures thereof wherein (TDP) is tris-(1,3-diphenyl-1-3-propanedione);
(e) a compound having the general chemical formula 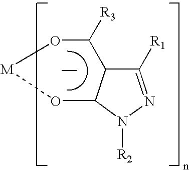
wherein M is a metal other than a rare earth, a transition metal, a lanthanide or an actinide; n is the valence of M; R₁, R₂ and R₃, which may be the same or different, are selected from the group consisting of hydrogen, hydrocarbyl groups, substituted and unsubstituted aliphatic groups, substituted and unsubstituted aromatic, heterocyclic and polycyclic ring structures, fluorocarbons, halogens, thiophenyl groups, and nitrile; R₁ and R₃ can also form ring structures, and R₁, R₂ and R₃ can be copolymerisable with a monomer;
(f) an electroluminescent diiridium compound having the general chemical formula 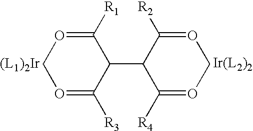
where R₁, R₂, R₃ and R₄ can be the same or different and are selected from the group consisting of hydrogen, and substituted and unsubstituted hydrocarbyl groups; R₁, R₂, R₃ and R₄ are selected from substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer and L₁ and L₂ are the same or different organic ligands and more preferably L₁ and L₂ are selected from phenyl pyridine and substituted phenylpryidines;
(g) an electroluminescent complex having the general chemical formula 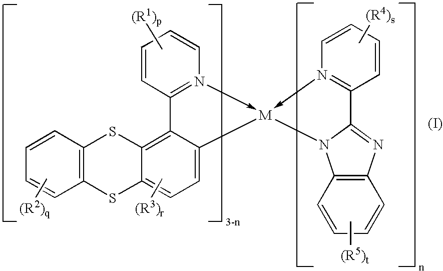
wherein M is selected from the group consisting of ruthenium, rhodium, palladium, osmium, iridium and platinum; n is 1 or 2; R₁, R₄ and R₅ can be the same or different and are selected from the group consisting of substituted and unsubstituted hydrocarbyl groups; substituted and unsubstituted monocyclic and polycyclic heterocyclic groups; substituted and unsubstituted hydrocarbyloxy and carboxy groups; fluorocarbyl groups; halogen; nitrile; amino; alkylamino; dialkylamino; arylamino; diarylamino; and thiophenyl; p, s and t are independently selected from 0, 1, 2 and 3, subject to the proviso that, where any one of p, s and t is 2 or 3, only one of them can be other than saturated hydrocarbyl or halogen; R₂ and R₃ can be the same or different and are selected from substituted and unsubstituted hydrocarbyl groups or halogen; and q and r are independently selected from 0, 1 or 2;
(h) a complex having the general chemical formula 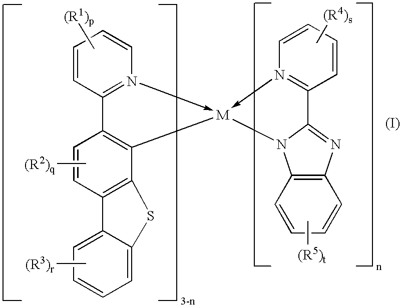
wherein M is selected from the group consisting of ruthenium, rhodium, palladium, osmium, iridium and platinum; n is 1 or 2; R₁-R₅ which may be the same or different are selected from substituted and unsubstituted hydrocarbyl groups; substituted and unsubstituted monocyclic and polycyclic heterocyclic groups; substituted and unsubstituted hydrocarbyloxy and carboxy groups; fluorocarbyl groups; halogen; nitrile; nitro; amino; alkylamino; dialkylamino; arylamino; diarylamino; N-alkylamido, N-arylamido, sulfonyl and thiophenyl; and R₂ and R₃ can additionally be alkylsilyl or arylsilyl; p, s and t are independently selected from 0, 1, 2 or 3, subject to the proviso that, where any one of p, s and t is 2 or 3, only one of them can be other than saturated hydrocarbyl or halogen; q and r are independently selected from 0, 1 or 2, subject to the proviso that, when q or r is 2, only one of them can be other than saturated hydrocarbyl or halogen;
(i) a compound having a general chemical formula selected from the group consisting of 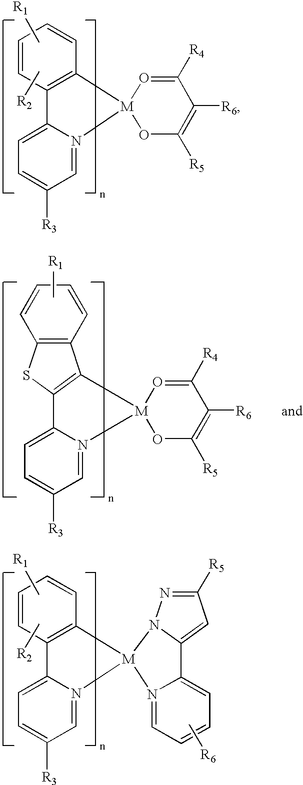
where R₁, R₂, R₃, R₄, R₅ and R₆ can be the same or different and are selected from hydrogen, substituted and unsubstituted hydrocarbyl groups, substituted and unsubstituted aliphatic groups, substituted and unsubstituted aromatic, heterocyclic and polycyclic ring structures, fluorocarbons, halogens and thiophenyl groups; R₁, R₂ and R₃ can also form substituted and unsubstituted fused aromatic, heterocyclic and polycyclic ring structures and can be copolymerisable with a monomer, and R₄ and R₅ can be the same or different and are selected from the group consisting of hydrogen, substituted and unsubstituted hydrocarbyl groups, substituted and unsubstituted aliphatic groups, substituted and unsubstituted aromatic, heterocyclic and polycyclic ring structures, fluorocarbons, halogens and thiophenyl groups; R₁, R₂ and R₃ can also form substituted and unsubstituted fused aromatic, heterocyclic and polycyclic ring structures and can be copolymerisable with a monomer; M is selected from the group consisting of ruthenium, rhodium, palladium, osmium, iridium and platinum; and n+2 is the valency of M;
(j) a compound having the general chemical formula 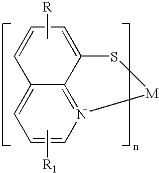
where M is a metal; n is the valency of M; R and R₁, which can be the same or different, are selected from the group consisting of hydrogen, substituted and unsubstituted hydrocarbyl groups, substituted and unsubstituted aliphatic groups, substituted and unsubstituted aromatic, heterocyclic and polycyclic ring structures, fluorocarbons, halogens; thiophenyl groups; cyano groups; substituted and unsubstituted hydrocarbyl groups, and substituted and unsubstituted aliphatic groups; and,
(k) compound having the general chemical formula 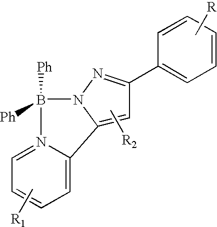
where Ph is an unsubstituted or substituted phenyl group where the substituents can be the same or different and are selected from the group consisting of hydrogen, substituted and unsubstituted hydrocarbyl groups, substituted and unsubstituted aliphatic groups, substituted and unsubstituted aromatic, heterocyclic and polycyclic ring structures, fluorocarbons, halogens and thiophenyl groups; R, R₁ and R₂ can be hydrogen or substituted or unsubstituted hydrocarbyl groups, substituted and unsubstituted aromatic, heterocyclic and polycyclic ring structures, fluorine, fluorocarbons, halogens, thiophenyl groups and nitrile.

41. The device of claim 35, wherein a layer of a hole transmitting material is located between the layer of the buffer material and the layer of the electroluminescent material.

42. The device of claim 41, in which the hole transmitting material is an aromatic amine is selected from the group consisting of:
(a) a polyaromatic amine;
(b) a polyaniline;
(c) a copolymer of aniline with o-anisidine, m-sulphanilic acid, o-aminophenol, o-toluidine, o-aminophenol, o-ethylaniline, o-phenylene diamine or an amino anthracene;
(d) a conjugated polymer selected from the group consisting of poly(p-phenylenevinylene)-PPV and copolymers comprising PPV, poly(2,5 dialkoxyphenylene vinylene), poly(2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) wherein at least one of the alkoxy groups is selected from the group consisting of a long chain solubilising alkoxy group, poly fluorenes, oligofluorenes, polyphenylenes, oligophenylenes, polyanthracenes, oligo anthracenes, polythiophenes and oligothiophenes; and
(e) a film of a polymer selected from the group consisting of poly(vinylcarbazole), N,N′-diphenyl-N,N′-bis(3-methylphenyl)-1,1′-biphenyl-4,4′-diamine(TPD), polyaniline, substituted polyanilines, polythiophenes, substituted polythiophenes, polysilanes and substituted polysilanes.

43. The device of claim 41, in which the hole transmitting material is selected from α-NBP, TPD and mTADATA.

44. The device of claim 35 wherein a layer of an electron transmitting material is located between the cathode and the layer of the electroluminescent material.

45. The device of claim 44 in which the electron transmitting material is a metal quinolate.

46. The device of claim 45 wherein the metal quinolate is aluminum quinolate or lithium quinolate.

47. The device of claim 44 in which the electron transmitting material is selected from the group consisting of:
(a) a material having the general chemical formula Mx(DBM)ₙ, where Mx is a metal, DBM is dibenzoyl methane, and n is the valency of Mx;
(b) a cyano anthracene;
(c) a polystyrene sulphonate; and
(d) a material selected from the group consisting of EDTA, DCTA, TTHA and DTVb1.

48. The device of claim 35, in which the first electrode is a transparent electricity conducting glass electrode.

49. The device of claim 35 in which the second electrode is selected from the group consisting from aluminum, calcium, lithium, magnesium and alloys thereof, and silver/magnesium alloys.

50. The device of claim 35, in which the buffer material is a metal p-tolyl porphonato complex.

51. The device of claim 50, wherein the metal in said complex is zinc.

52. The device of claim 35, wherein the buffer material is ZnTpTP (A).
